(19) United States
(12) Patent Application Publication
(10) Pub. No.: US 2019/0139350 A1
(43) Pub. Date: May 9, 2019

(54) MONEY PROCESSING DEVICE AND MONEY PROCESSING SYSTEM

(71) Applicant: GLORY LTD., HIMEJI-SHI (JP)

(72) Inventors: Akito KURODA, Himeji-shi (JP); Yusuke WATATANI, Akashi-shi (JP); Yosuke KITAMURA, Himeji-shi (JP)

(73) Assignee: GLORY LTD., HIMEJI-SHI (JP)

(21) Appl. No.: 16/181,452

(22) Filed: Nov. 6, 2018

(30) Foreign Application Priority Data
Nov. 8, 2017 (JP) 2017-215598

(51) Int. Cl. G07D 11/00

(52) U.S. Cl. CPC G07D 11/0072; G07D 11/0036; G07D 11/0018; G07D 11/0027; G07D 7/00; G07D 11/0012; G07D 2211/00; G07D 2207/00; G07D 2205/00; G07D 11/0009

(57) ABSTRACT

A money processing device includes at least one money container that contains money; a controller operable to control a process on the money container; and a storage. The storage stores a condition for deciding which of a plurality of check processes to be performed, wherein the plurality of check processes include: a quick check process in which the money in the at least one money container is not counted when an event in which an amount of money held in the at least one money container may become indefinite has not occurred; and a general check process in which the money in the at least one money container is counted regardless of the presence or absence of an occurrence of the event. The controller executes one of the quick check process and the general check process based on the condition stored in the storage.

### CROSS REFERENCE TO RELATED APPLICATION

This application claims priority under 35 U.S.C. Section 119 of Japanese Patent Application No. 2017-215598 filed Nov. 8, 2017, entitled “MONEY PROCESSING DEVICE AND MONEY PROCESSING SYSTEM”. The disclosure of the above application is incorporated herein by reference.

### BACKGROUND OF THE INVENTION

### 1. Technical Field

The present invention relates to a money processing device and a money processing system that perform processes such as deposits and withdrawals of money.

### 2. Description of the Related Art

Various money processing devices installed in finance institutions manage the amounts of money held in the individual devices as money amount data and execute a check process to check whether there is a match between the data on the amounts of money and the actual amounts of money at the close of business of a day, for example. Besides, automatic transaction devices such as automated teller machines (ATMs) execute a process to notify the present amounts of money held in the individual devices to a host computer that manages the amounts of money held in the individual devices to ensure the correctness of the amounts of money held in the devices.

JP 2016-31686 A describes an automatic transaction device that notifies the amount of money held in the device to a host computer. The automatic transaction device executes a check process with counting of the money in the device or a check process without counting of the money in the device, depending on whether an event has occurred in which the amount of money held in the device may become indefinite. Specifically, at the occurrence of an event in which the amount of money held in the device may become indefinite, the device executes the check process with counting of the money, whereas, without occurrence of an event in which the amount of money held in the device may become indefinite, the device executes either the check process with counting of the money held in the device or the check process without counting of the money held in the device, according to the operator's selection and instruction on the screen.

In financial institutions and others, it may be desired to change arbitrarily the kinds and contents of the check processes in consideration of the business schedule and the trend to operate the devices. However, according to the configuration described in JP 2016-31686 A, switching takes place between the check processes on the device side depending on whether there has occurred an event in which the amount of money held in the device may become indefinite, and therefore it is impossible to change arbitrarily the contents of the check process in the mode desired by the user.

### SUMMARY OF THE INVENTION

A first aspect of the present invention relates to a money processing device. The money processing device according to this aspect includes: at least one money container that contains money; a controller operable to control a process on the money container; and a storage. The storage stores a condition for deciding which of a plurality of check processes to be performed, wherein the plurality of check processes include: a quick check process in which the money in the at least one money container is not counted when an event in which an amount of money held in the at least one money container may become indefinite has not occurred; and a general check process in which the money in the at least one money container is counted regardless of the presence or absence of an occurrence of the event. The controller executes one of the quick check process and the general check process based on the condition stored in the storage.

A second aspect of the present invention relates to a money processing system comprising a money processing device with a money container and a management device connected to the money processing device. The money processing system according to this aspect includes a controller and a storage. The storage stores a condition for deciding which of a plurality of check processes to be performed, wherein the plurality of check processes include: a quick check process in which the money in the money container is not counted when an event in which the amount of money held in the money container may become indefinite has not occurred; and a general check process in which the money in the money container is counted regardless of the presence or absence of an occurrence of the event. The controller executes either the quick check process or the general check process based on the condition stored in the storage.

### BRIEF DESCRIPTION OF THE DRAWINGS

The foregoing and other objects and novel features will be completely clarified by reading subsequent descriptions of embodiments with reference to the accompanying drawings listed below.

FIG. 1 is a perspective view of a configuration of a money deposit/withdrawal machine according to an embodiment;

FIG. 2 is a diagram illustrating a configuration of a paper money deposit/withdrawal unit according to the embodiment;

FIG. 3 is a diagram illustrating a configuration of a coin deposit/withdrawal unit according to the embodiment;

FIG. 4 is a block diagram illustrating a configuration of the money deposit/withdrawal machine according to the embodiment;

FIG. 5 is a block diagram illustrating a configuration of the money deposit/withdrawal machine according to the embodiment;

FIGS. 6A to 6D are diagrams schematically illustrating the flow of paper money at the time of a general check process in the paper money deposit/withdrawal unit according to the embodiment;

FIGS. 7A to 7F are diagrams schematically illustrating the flow of coins at the time of a general check process in the coin deposit/withdrawal unit according to the embodiment;

FIGS. 8A to 8D are diagrams illustrating screen transitions in the general check process according to the embodiment;

FIGS. 9A and 9B are diagrams illustrating screens displayed in the general check process according to the embodiment;

FIGS. 10A to 10D are diagrams illustrating screen transitions in the quick check process according to the embodiment;

FIGS. 11A and 11B are diagrams illustrating screens displayed in the quick check process according to the embodiment;

FIG. 12A is a flowchart of a screen display process at the check process according to the embodiment, and FIG. 12B is a flowchart of the check process according to the embodiment;

FIG. 13 is a flowchart of the quick check process according to the embodiment;

FIG. 14A is a flowchart of the general check process according to the embodiment, and FIG. 14B is a flowchart of a process under an instruction for checking from an upper-level terminal according to the embodiment;

FIG. 15A is a flowchart of a process under an instruction for checking from an upper-level terminal according to the modification example; and FIG. 15B is a flowchart of a check process according to the modification example;

FIG. 16 is a block diagram illustrating a configuration of a money processing system according to the modification example;

FIGS. 17A to 17D are diagrams illustrating screens displayed in the quick check process under a preset condition according to another modification example; and

FIGS. 18A to 18D are diagrams illustrating screens for setting a condition for switching between the quick check process and the general check process according to still another modification example.

However, it is noted that the drawings are intended only for illustration and do not limit the scope of the present invention.

### DESCRIPTION OF PREFERRED EMBODIMENTS

An embodiment of the present invention will be described below with reference to the drawings. In relation to the present embodiment, a money deposit/withdrawal machine having a function of counting money and a function of depositing and withdrawing money is taken as an example of a money processing device. The drawings include as appropriate arrows indicating the upward, downward, rightward, leftward, forward, and backward directions of the money deposit/withdrawal machine.

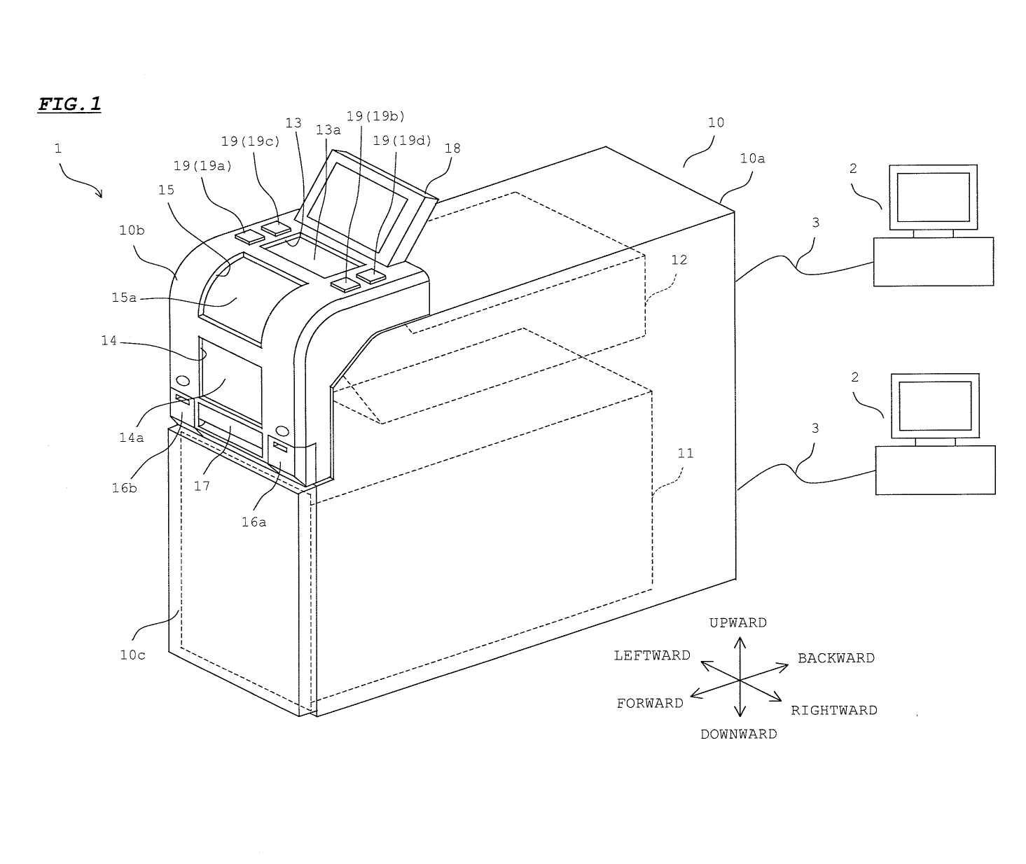

FIG. 1 is a perspective view of a configuration of a money deposit/withdrawal machine 1.

The money deposit/withdrawal machine 1 is installed between two tellers inside a service counter in a financial institution such as a bank. The money deposit/withdrawal machine 1 is connected to upper-level terminals 2 operated by the tellers via communication cables 3.

The money deposit/withdrawal machine 1 includes a paper money deposit/withdrawal unit 11 and a coin deposit/withdrawal unit 12 in an exterior body 10 constituting an outer shell. The paper money deposit/withdrawal unit 11 is provided on the lower inner side of the exterior body 10 to perform deposits and withdrawals of paper money. The coin deposit/withdrawal unit 12 is provided on the upper inner side of the exterior body 10 to perform deposits and withdrawals of coins.

As illustrated in FIG. 1, the exterior body 10 has the shape of an almost rectangular solid in which the depth is larger than the width and the height is larger than the width. The exterior body 10 includes a main body 10a, an exterior cover 10b provided on the upper front part of the main body 10a, and a door 10c provided on the front side of the main body 10a. For example, the exterior cover 10b is formed from a resin material, and the main body 10a and the door 10c are formed from a metallic material.

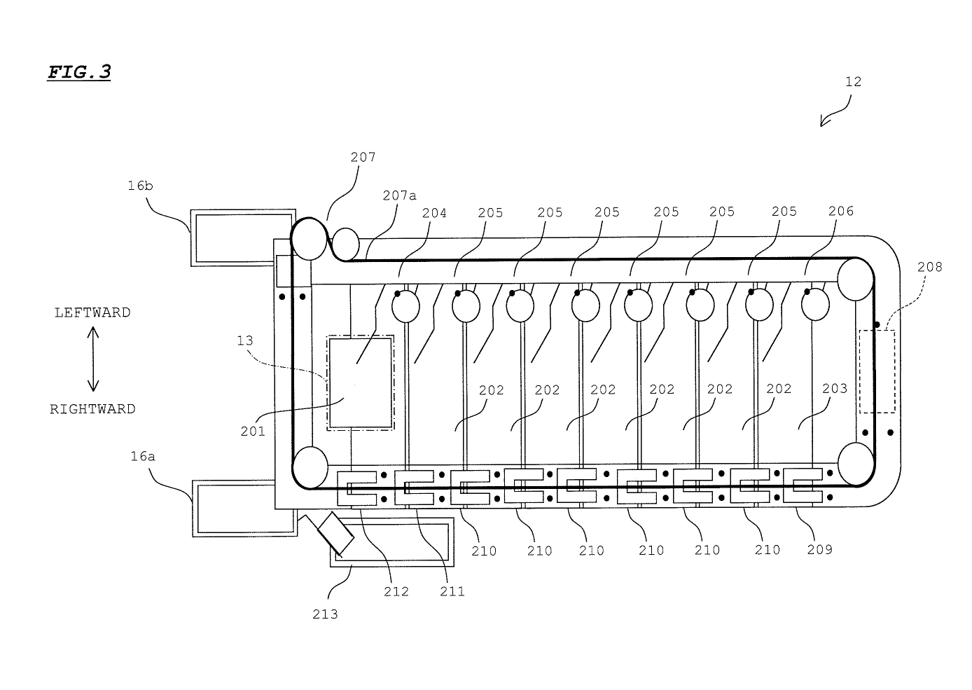

The exterior cover 10b is supported on the main body 10a in such a manner as to be upward rotatable. Turning upward the exterior cover 10b makes it possible to pull open the coin deposit/withdrawal unit 12 and access coin stackers 202 (see FIG. 3) mounted in the coin deposit/withdrawal unit 12 and the like.

The exterior cover 10b has a coin deposit port 13 on the top surface, a paper money withdrawal port 14 on the front surface, and a paper money deposit port 15 on a curve surface from the top to front surfaces. The coin deposit port 13, the paper money withdrawal port 14, and the paper money deposit port 15 are opened or closed by respective shutters 13a, 14a, and 15a.

The exterior cover 10b has coin withdrawal boxes 16a and 16b on both the right and left ends of the lower part and a reject box 17 between the coin withdrawal boxes 16a and 16b. The coin withdrawal boxes 16a and 16b can be pulled and removed. The coin withdrawal boxes 16a and 16b are identical in shape (in symmetry) and equal in capacity. The reject box 17 can be pulled open. The reject box 17 is designed to contain reject paper money.

The exterior cover 10b has an operation display module 18 on the rear part. The operation display module 18 is fixed to the exterior cover 10b and oriented in an obliquely upward and forward direction. The operation display module 18 is formed from a touch panel including a display and a touch sensor. The operation display module 18 displays various images (screens) on the display and detects user touch operations on the display by the touch sensor.

The top surface of the exterior cover 10b has four occupancy keys 19 in regions on the both sides of the coin deposit port 13. The four occupancy keys 19 include occupancy keys 19a and 19b that are to be operated by the right and left tellers to instruct for the occupancy of transaction processes related to the paper money in the money deposit/withdrawal machine 1 and occupancy keys 19c and 19d to be operated by the right and left tellers to instruct for the occupancy of transaction processes related to the coins in the money deposit/withdrawal machine 1.

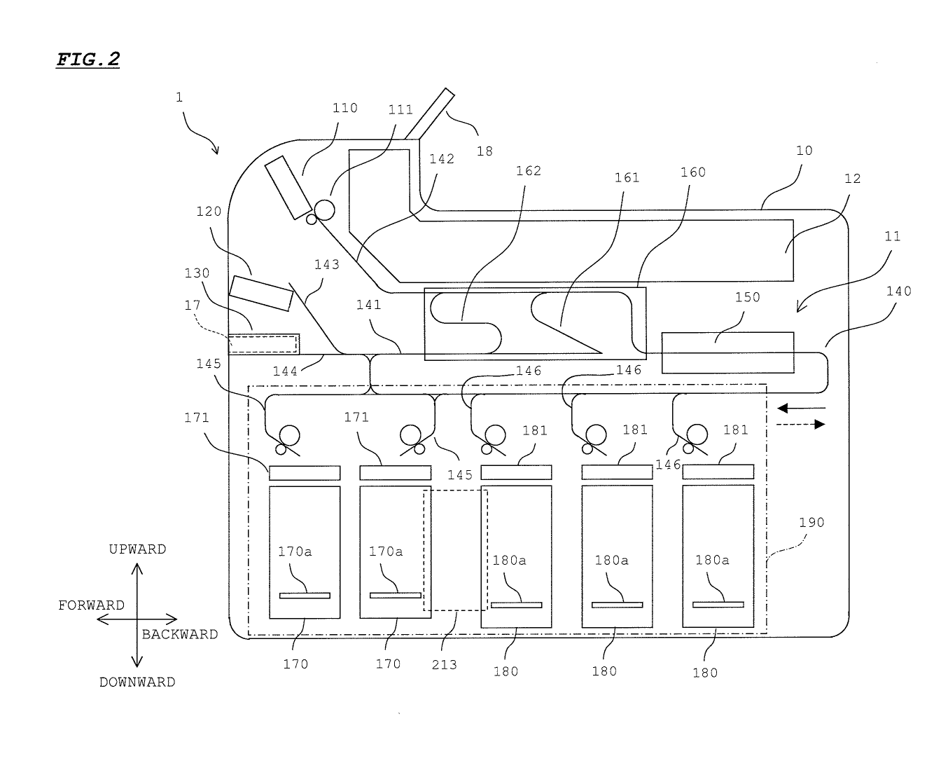

FIG. 2 is a diagram schematically illustrating a configuration of a paper money deposit/withdrawal unit 11.

The paper money deposit/withdrawal unit 11 includes a deposit module 110, a withdrawal module 120, a rejecter 130, a conveyance module 140, an identification module 150, a paper money alignment module 160, two paper money cassettes 170, two temporary holders 171 for the paper money cassettes 170, three paper money stackers 180, and three temporary holders 181 for the paper money stackers 180.

The deposit module 110, the withdrawal module 120, and the rejecter 130 are provided near the upper front inner position of the exterior body 10. The deposit module 110 is connected to the paper money deposit port 15 so that loose paper money is put into the deposit module 110 through the paper money deposit port 15. The withdrawal module 120 is connected to the paper money withdrawal port 14 so that loose paper money is taken out from the withdrawal module 120 through the paper money withdrawal port 14. The rejecter 130 includes the reject box 17 to contain the reject paper money in the reject box 17.

The deposit module 110 includes a deposit feed mechanism 111. The deposit feed mechanism 111 feeds paper money in the deposit module 110 one by one to the conveyance module 140. The withdrawal module 120 receives mainly the paper money fed from the paper money stackers 180. The rejecter 130 receives mainly the paper money that is not deemed as normal paper money because its attributes (authenticity, denomination, and others) were not identified by the identification module 150.

The conveyance module 140 is formed from a belt mechanism, a roller mechanism, and others, and includes a main conveyance path 141, a deposit conveyance path 142, a withdrawal conveyance path 143, a reject conveyance path 144, two cassette conveyance paths 145, and three stacker conveyance paths 146. The main conveyance path 141 is formed in a loop extending in a front-back direction in the exterior body 10 and can convey the paper money clockwise and counterclockwise in FIG. 2.

The deposit conveyance path 142 is provided between the deposit module 110 and the main conveyance path 141. The withdrawal conveyance path 143 is provided between the withdrawal module 120 and the main conveyance path 141. The reject conveyance path 144 is provided between the rejecter 130 and the main conveyance path 141. The cassette conveyance paths 145 are provided between the paper cassettes 170 and the temporary holders 171, and the main conveyance path 141. The stacker conveyance paths 146 are provided between the paper money stackers 180 and the temporary holders 181, and the main conveyance path 141.

The identification module 150 is provided on the upper back part of the loop of the main conveyance path 141. The identification module 150 identifies the attributes of the paper money flowing in the conveyance module 140 and outputs the identification results to a controller described later.

The identified attributes include the authenticity, denomination, front/back orientation of the paper money. The identification module 150 also counts the paper money and outputs the counting results to the controller described later.

The paper money alignment module 160 is provided to align the front/back orientation of the paper money flowing in the conveyance module 140. The paper money alignment module 160 is arranged in front of the identification module 150, that is, downstream of the identification module 150 in the flow of the paper money at the time of withdrawal. The paper money alignment module 160 includes a reverse portion 161 and a non-reverse portion 162 constituting part of the main conveyance path 141.

The reverse portion 161 includes a reverse mechanism that reverses the paper money by a switch back method. The paper money having passed through the reverse portion 161 is reversed between the front/back orientations along the short side of the paper money, that is, in the vertical direction, so that the front/back orientation and the up/down orientation of the paper money are changed. The non-reverse portion 162 is almost the same in path length as the reverse portion 161 and lets the paper money pass in the present orientation. For example, the paper money identified as being in a face-up orientation by the identification module 150 passes through the non-reverse portion 162 and the paper money identified as being in the face-down orientation by the identification module 150 passes through the reverse portion 161, so that all the paper money is aligned in the face-up orientation.

The two paper money cassettes 170 and the three paper money stackers 180 are aligned in a front-back direction in the exterior body 10 under the conveyance module 140. The two paper money cassettes 170 are provided in front of the three paper money stackers 180. The paper money cassettes 170 and the paper money stackers 180 are supported by a support module 190 that can be pulled toward the front. Opening the door 10c makes it possible to take the paper money cassettes 170 and the paper money stackers 180 into or out of the exterior body 10.

The paper money cassettes 170 is used mainly to contain the paper money collected from the paper money stackers 180 and the paper money to be supplied into the paper money stackers 180. The paper money cassettes 170 are used to contain temporally the paper money in the automatic check process for automatically checking the paper money in the paper money stackers 180. One of the paper money cassettes 170 can be used to contain 2,000-yen bills, old bills, damaged bills, and others. The paper money is contained in a vertical stack in the paper money cassettes 170. To move upward and downward the contained paper money, a lift stage 170a is provided in each of the paper money cassettes 170.

On the right side of these paper money cassettes 170, a coin cassette 213 is arranged to collect coins. The coin cassette 213 is also supported by the support unit 190 and can be pulled toward the front. At the time of collection of coins, the coins from the coin deposit/withdrawal unit 12 are put into the coin cassette 213. Besides, the coin cassette 213 is also used to contain damaged coins and coins overflowing from the coin stackers 202.

When the support unit 190 is pulled toward the front, the operators (including persons other than the tellers) can touch the paper money in the paper money cassettes 170 and the paper money stackers 180 but cannot touch the coins in the coin cassette 213. After pulling the support unit 190 toward the front, the operators detach the coin cassette 213 from the support unit 190 to touch the coins in the coin cassette 213.

The temporary holders 171 for the paper money cassettes 170 are arranged above the corresponding paper money cassettes 170. The temporary holders 171 hold (contain) temporally the paper money to be contained in the paper money cassettes 170. Each of the temporary holders 171 has a feed mechanism (not illustrated) at the inlet/outlet side to feed the paper money in the paper money cassette 170 to the cassette conveyance path 145 through the temporary holder 171.

The paper money stackers 180 are used to contain the deposited paper money by denomination. For example, the denominations of 10,000 yen, 1,000 yen, and 5,000 yen can be assigned to the three paper money stackers 180. The paper money is vertically stacked in the paper money stackers 180. To move upward and downward the contained paper money, a lift stage 180a is provided in each of the paper money stackers 180.

The temporary holders 181 for the paper money stackers 180 are arranged above the corresponding paper money stackers 180. The temporary holders 181 hold (contain) temporally the paper money to be contained in the paper money stackers 180. Each of the temporary holders 181 has a feed mechanism (not illustrated) at the inlet/outlet side to feed the paper money in the paper money stackers 180 to the stacker conveyance path 146 through the temporary holder 181.

At the time of deposition of paper money, the paper money put into the deposit module 110 through the paper money deposit port 15 is conveyed by the conveyance module 140 and identified by the identification module 150. The paper money identified as being normal is temporally held in the corresponding temporary holders 181 by denomination. Then, when a confirmation operation is performed, the paper money in the temporary holder 181 is contained in the corresponding paper money stacker 180. The paper money identified as being not normal is returned to the rejecter 130.

At the time of withdrawal of paper money, an amount of paper money specified by the withdrawal operation is fed from the paper money stacker 180 and conveyed by the conveyance module 140. In the meanwhile, the paper money is aligned in the same direction by the paper money alignment module 160 and is discharged into the withdrawal module 120. The paper money is taken out from the withdrawal module 120 through the paper money withdrawal port 14.

FIG. 3 is a schematic top view of a configuration of the coin deposit/withdrawal unit 12 mounted in the money deposit/withdrawal machine 1.

The coin deposit/withdrawal unit 12 includes a coin acceptor 201, six coin stackers 202, and a collective holder 203.

The coin acceptor 201 is arranged below the coin deposit port 13 to accept the coins put into the coin deposit port 13. The coins put into the coin deposit port 13 drop into the coin acceptor 201. The six coin stackers 202 contain the coins by denomination. For example, the six coin stackers 202 contain respectively 1-yen coins, 5-yen coins, 10-yen coins, 100-yen coins, and 500-yen coins in order from the front side of the coin deposit/withdrawal unit 12. The collective holder 203 temporally contains the coins in the deposition/withdrawal processes, the check process, and the process of collecting the coins from the coin stackers 202.

The coin deposit/withdrawal unit 12 further includes a coin feeding mechanism 204 associated with the coin acceptor 201 respectively, coin feeding mechanisms 205 associated with the six coin stackers 202, and a coin feeding mechanism 206 associated with the collective holder 203, a conveyance module 207, and an identification module 208.

The coin feeding mechanism 204 feeds the coins accepted by the coin acceptor 201 one by one to the conveyance module 207. The six coin feeding mechanisms 205 feed the coins contained in the corresponding coin stackers 202 one by one to the conveyance module 207. The coin feeding mechanism 206 feeds the coins contained in the collective holder 203 one by one to the conveyance module 207.

The conveyance module 207 includes a circulation belt 207a that circulates in a clockwise direction. The circulation belt 207a has a plurality of projections (not illustrated) at equal intervals. The coins get caught on the projections on the circulation belt 207a so that the coins are conveyed one by one along the circulating movement of the circulation belt 207a. Accordingly, the coins fed by the foregoing feeding mechanisms are conveyed along the circulation pathway of the circulation belt 207a.

The identification module 208 is provided on the coin conveyance pathway to identify the denomination and authenticity of the coins conveyed one by one by the conveyance module 207. The information on the coins identified by the identification module 208 is transmitted to a controller 31 described later.

The coin deposit/withdrawal unit 12 further includes a branch mechanism 209 associated with the collective holder 203, branch mechanisms 210 associated with the six coin stackers 202, a branch mechanism 211 associated with the coin deposit port 13, and a branch mechanism 212 associated with the coin withdrawal box 16a.

The branch mechanism 209 selectively branches the coins conveyed by the conveyance module 207 from the conveyance module 207 and sends the coins to the collective holder 203. The six branch mechanisms 210 selectively branch the coins conveyed by the conveyance module 207 from the conveyance module 207 and sends the coins to the corresponding coin stackers 202. The branch mechanism 211 selectively branches the coins conveyed by the conveyance module 207 from the conveyance module 207 and sends the same to a transport module (not illustrated) that transports the coins to the coin deposit port 13 (the coin acceptor 201). The branch mechanism 212 selectively branches the coins conveyed by the conveyance module 207 from the conveyance module 207 and sends the same to a sorting mechanism (not illustrated) that sorts the coins into the coin withdrawal box 16a and the coin cassette 213. The coins not branched by the branch mechanism 212 are all sent by the conveyance module 207 to the coin withdrawal box 16b.

The tellers on the right and left sides of the money deposit/withdrawal machine 1 can use the money deposit/withdrawal machine 1 to perform a deposit process, a withdrawal process, a count process of counting the paper money and the coins put into the money deposit/withdrawal machine 1, and a check process of counting the money contained in the money deposit/withdrawal machine 1 and checking the amount of money by denomination. In the present embodiment, as the check process, the quick check process and the general check process can be performed.

The quick check process is a check process in which the money contained in the money containers (the paper money stackers 180, the paper money cassettes 170, the coin stackers 202, and the coin cassette 213) is not counted when there is no occurrence of an event in which the amount of money in the money containers may be indefinite. The general check process is a check process in which the money contained in the money containers (the paper money stackers 180, the paper money cassettes 170, the coin stackers 202, and the coin cassette 213) is counted regardless of the presence or absence of an event in which the amount of money may be indefinite.

In the present embodiment, a condition for deciding which of the quick check process and the general check process to be performed is set in the storage of the money deposit/withdrawal machine 1. Under the condition, switching takes place between the check processes to be executed. The condition for deciding which of the quick check process and the general check process to be performed and the flow of the check process under the condition will be described later in detail.

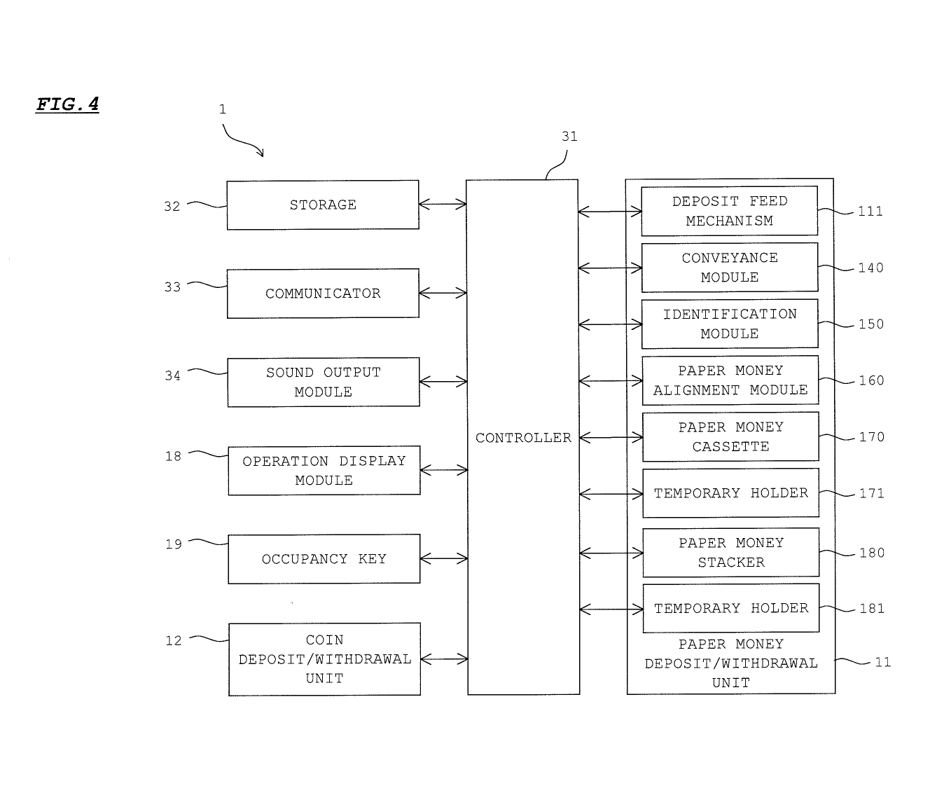

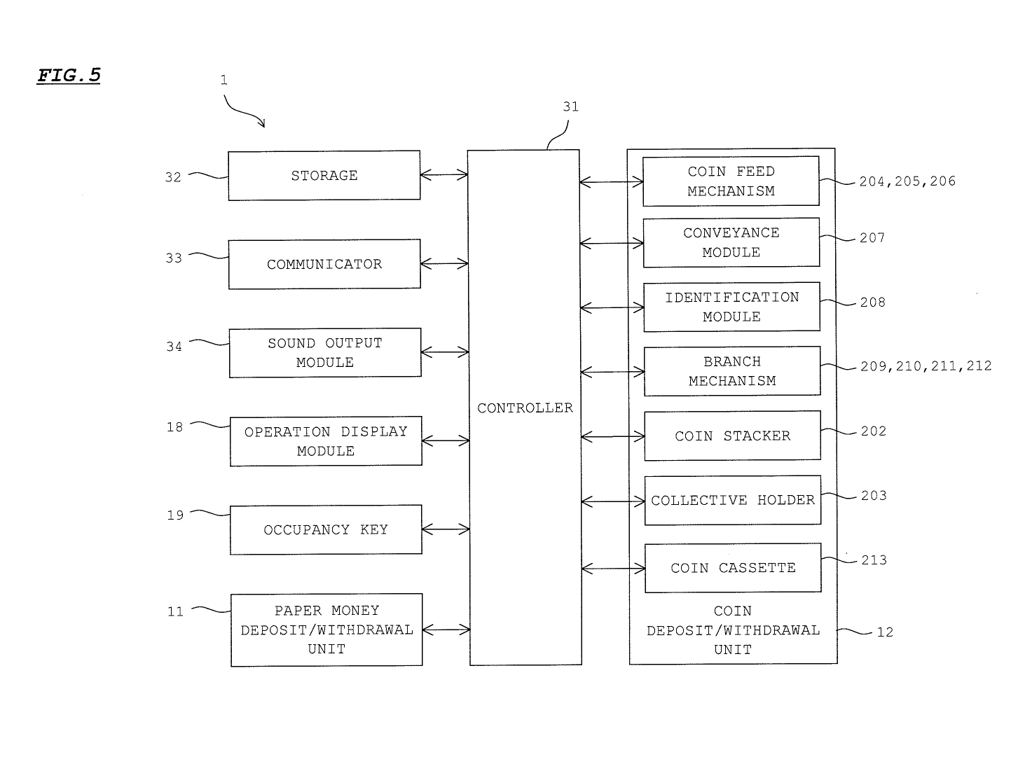

FIGS. 4 and 5 are block diagrams illustrating a configuration of the money deposit/withdrawal machine 1. FIG. 4 illustrates main components relating to the paper money deposit/withdrawal unit 11, and FIG. 5 illustrates main components related to the coin deposit/withdrawal unit 12.

As illustrated in FIGS. 4 and 5, the money deposit/withdrawal machine 1 includes the paper money deposit/withdrawal unit 11, the coin deposit/withdrawal unit 12, the operation display module 18, and the occupancy keys 19 described above, and also includes a controller 31, a storage 32, a communicator 33, and a sound output module 34.

The controller 31 includes a computing circuit such as central processing unit (CPU) to control the individual components according to operation programs stored in the storage 32. The storage 32 includes storage media such as a read only memory (ROM), a random access memory (RAM), and a hard disc to store the operation programs for the controller 31, and is used as a work area in control processing by the controller 31. The communicator 33 communicates with the upper-level terminals 2. The sound output module 34 includes a speaker to output predetermined sounds under control of the controller 31.

In the money deposit/withdrawal machine 1 configured as described above, transaction logs are stored in the storage 32 according to transaction processes such as deposition and withdrawal, and the amount of money held in the money deposit/withdrawal machine 1 is managed. In a financial institution, the check process is performed at a predetermined timing such as the closing of business to ascertain whether there is a match between the amount of money information stored in the storage 32 and the actual amount of money held in the money deposit/withdrawal machine 1. As described above, in the present embodiment, the two check processes, the quick check process and the general check process, are selectively performed.

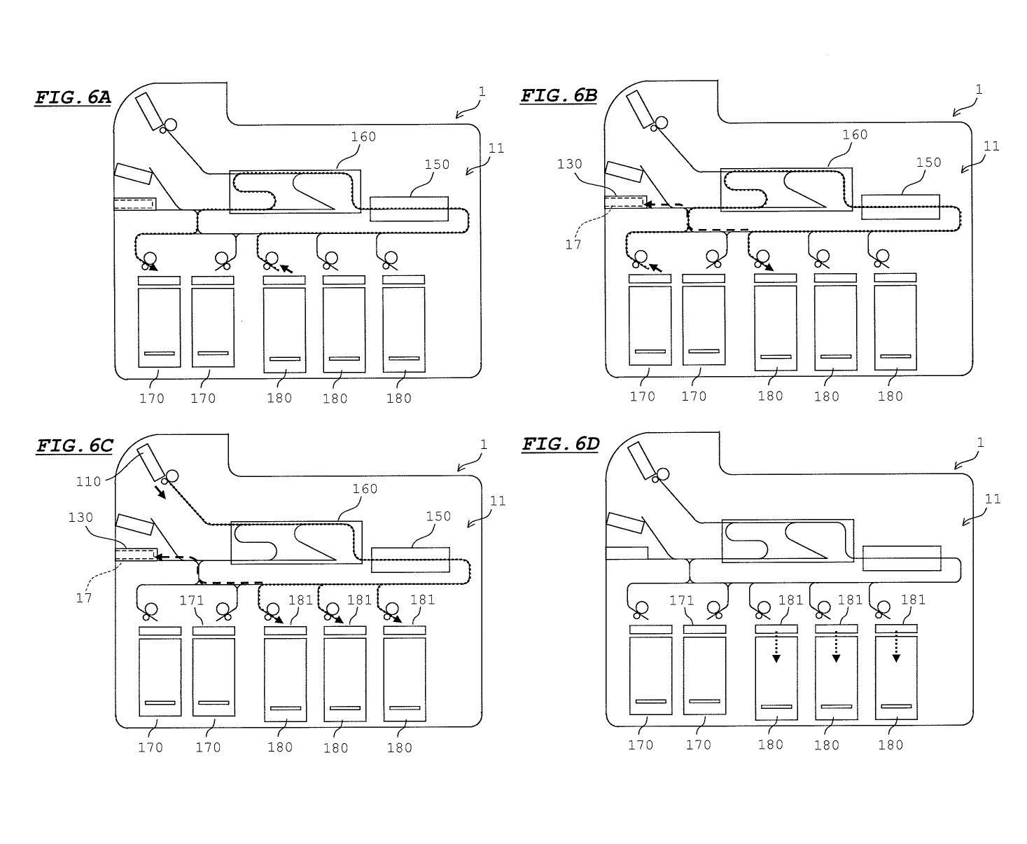

FIGS. 6A to 6D are diagrams schematically illustrating the flow of paper money in the paper money deposit/withdrawal unit 11 at the time of the general check process. In FIGS. 6A to 6D, the dotted lines indicate the general flow of the paper money and the broken lines indicate the flow of the reject paper money.

First, as illustrated in FIG. 6A, the paper money is fed from one of the three paper money stackers 180, and the fed paper money is sent to the corresponding paper money cassette 170. In the example of FIG. 6A, the paper money from the paper money stacker 180 at the left end is sent to the paper money cassette 170 on the left side. In this manner, all the paper money contained in the one paper money stacker 180 is sent to the predetermined paper money cassette 170. In the process of sending of the paper money from the paper money stacker 180 to the paper money cassette 170, the paper money is not identified or counted by the identification module 150.

Next, as illustrated in FIG. 6B, the paper money is fed one by one from the paper money cassette 170 and sent to the identification module 150. At this time, the paper money is identified and counted by the identification module 150. The paper money is sent to the corresponding paper money stacker 180 or the rejecter 130 depending on the results of identification by the identification module 150. Specifically, the normal paper money is sent to the corresponding paper money stacker 180, and the non-identifiable reject paper money is sent to the rejecter 130. In this way, the counting of the paper money in the one paper money stacker 180 is completed.

The same process as illustrated in FIGS. 6A and 6B are performed on the two remaining paper money stackers 180. Accordingly, the paper money in the two remaining paper money stackers 180 is counted. In this way, when the counting of the paper money in all the paper money stackers 180 is completed, then the reject paper money sent to the reject box 17 by the foregoing process is returned to the corresponding paper money stackers 180. The operator removes the reject paper money from the reject box 17 and puts the removed paper money into the deposit module 110.

Accordingly, as illustrated in FIG. 6C, the paper money is fed one by one from the deposit module 110 and sent to the identification module 150. After that, the paper money is sent to the temporary holders 181 of the corresponding paper money stackers 180 or the rejecter 130 depending on the results of identification by the identification module 150. When the reject paper money is sent again to the rejecter 130, the operator replaces as appropriate the reject paper money with normal paper money of the corresponding denomination and put the replacement into the deposit module 110.

In this way, the operation illustrated in FIG. 6C is repeated and all the paper money is contained in the temporary holders 181 of the corresponding paper money stackers 180. Then, the operator performs a confirmation operation on the operation display module 18. Accordingly, as illustrated in FIG. 6D, the paper money contained in the temporary holders 181 is contained in the corresponding paper money stackers 180. Thus, the general check process on the paper money deposit/withdrawal unit 11 is completed.

When old bills or damaged bills are contained in the paper money cassette 170 on the right side, the same operations as illustrated in FIGS. 6A and 6B are performed on the paper money cassettes 170 on the right side before execution of the operations illustrated in FIGS. 6C and 6D.

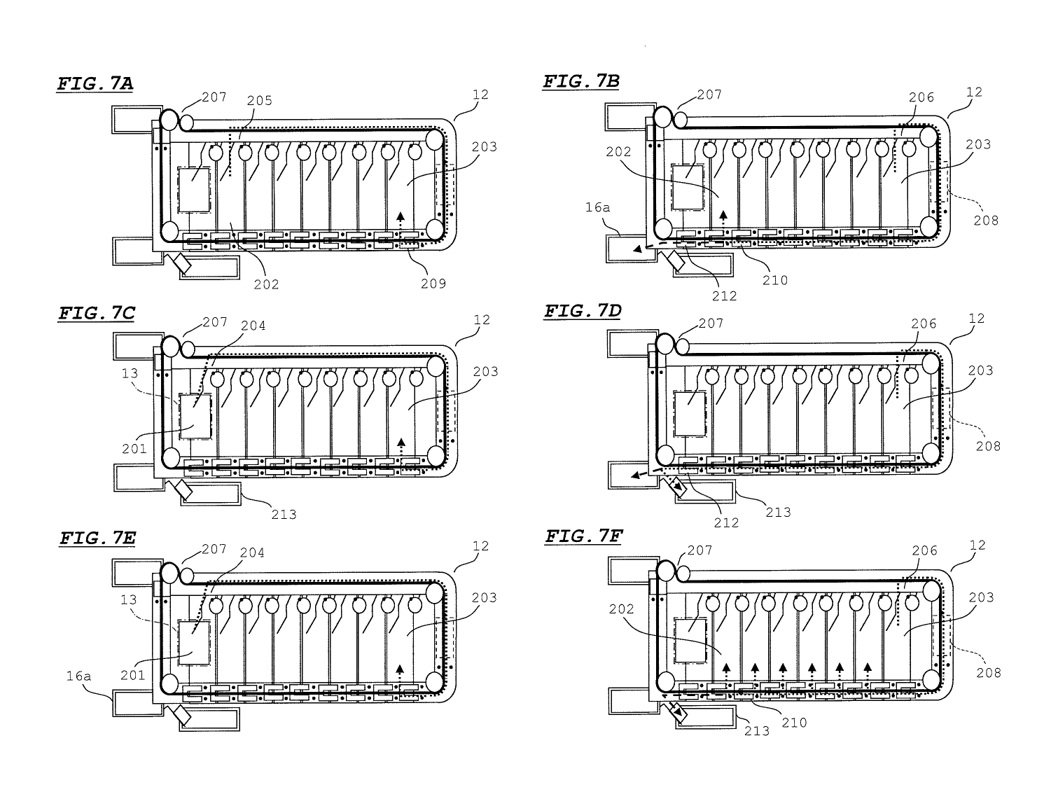

FIGS. 7A to 7F are diagrams schematically illustrating the flow of coins in the general check process in the coin deposit/withdrawal unit 12. In FIGS. 7A to 7F, the dotted lines indicate the flows of normal coins, and the broken lines indicate the flows of reject coins. In this example, the reject coins are carried to the coin withdrawal box 16a on the right side.

First, as illustrated in FIG. 7A, the coins are fed from one of the six coin stackers 202, and the fed coins are sent to the collective holder 203. In the example of FIG. 7A, the coins in the coin stacker 202 at the left end are sent to the collective holder 203. In this way, all the coins contained in the one coin stacker 202 are sent to the collective holder 203. In the course of sending the coins from the coin stacker 202 to the collective holder 203, the coins are not identified or counted by the identification module 208.

Next, as illustrated in FIG. 7B, the coins are fed one by one from the collective holder 203 and sent to the identification module 208. At this time, the coins are identified and counted by the identification module 208. The coins are sent to the corresponding coin stackers 202 or coin withdrawal box 16a depending on the results of identification by the identification module 150. Specifically, the normal coins are sent to the corresponding coin stackers 202, and the non-identifiable reject coins are sent to the coin withdrawal box 16a. In this way, the counting of the coins in the one coin stacker 202 is completed.

The same processes as illustrated in FIGS. 7A and 7B are performed on the five remaining coin stackers 202. Accordingly, the counting of the coins in the five remaining coin stackers 202 is executed. When the counting of the coins in all the coin stackers 202 is completed, then the coins in the coin cassette 213 are counted. In this example, the coins are removed from the coin cassette 213, and the removed coins are put into the coin acceptor 201 via the coin deposit port 13.

Accordingly, as illustrated in FIG. 7C, the coins are fed from the coin acceptor 201, and the fed coins are sent to the collective holder 203. After that, as illustrated in FIG. 7D, the coins are fed one by one from the collective holder 203 and sent to the identification module 208. Then, the coins are identified and counted by the identification module 208. The coins are sent to the coin cassette 213 or the coin withdrawal box 16a depending on the results of identification by the identification module 208. Specifically, the normal coins are sent to the coin cassette 213, and the non-identifiable reject coins are sent to the coin withdrawal box 16a. In this way, the counting of the coins in the coin cassette 213 is completed.

Next, an operation by which the reject coins sent to the coin withdrawal box 16a by the foregoing process are returned to the corresponding coin stackers 202 or the coin cassette 213 is performed. In this operation, the reject coins are removed from the coin withdrawal box 16a and put into the coin acceptor 201. Accordingly, all the put coins are sent to the collective holder 203 as illustrated in FIG. 7E.

After that, as illustrated in FIG. 7F, the coins are fed one by one from the collective holder 203 and sent to the identification module 208. At this time, the coins are identified and counted by the identification module 208. The coins are sent to the corresponding coin stacker 202 or the coin cassette 213 depending on the results of identification by the identification module 150. When there is any reject coin, the reject coin is sent to the coin withdrawal box 16a and the operator repeats the same operation. In this way, the general check process on the coin deposit/withdrawal unit 12 is completed.

As described above, in the general check process, the paper money in all the money containers (the paper money stackers 180 and the paper money cassettes 170) in the paper money deposit/withdrawal unit 11 is counted and the coins in all the money containers (the coin stackers 202 and the coin cassette 213) in the coin deposit/withdrawal unit 12 are counted. That is, the general check process is a check process for checking the money in a more precise manner.

In contrast, in the quick check process, the money is not counted in the money container without the occurrence of a predetermined event in which the amount of money may be indefinite but the money is counted only in the money container with the occurrence of a predetermined event in which the amount of money may be indefinite. That is, the quick check process is a check process for checking the money in a simpler and more efficient manner. In the quick check process, the operations illustrated in FIGS. 6A to 6D and 7A to 7F are executed only in the money container with the occurrence of a predetermined event in which the amount of money may be indefinite.

The matter that “the amount of money is indefinite” means that it is not definite that the actual amount of money contained in the money containers matches the amount of money managed in the transaction log. Therefore, examples of a predetermined event in which the amount of money may be indefinite include an event that money may have been improperly picked out of a money container and an event that the information on the amount of money in the transaction log may have been incorrectly updated. In the present embodiment, examples of an event in which the amount of money may be indefinite include, but not limited to, the events listed below.

### <The Amounts of Money Held in the Money Containers of the Paper Money Deposit/Withdrawal Unit 11>

(1) The paper money deposit/withdrawal unit 11 is in an abnormal state.
(2) The door 10c is opened and the support unit 190 is pulled open.
(3) Any of the paper money cassettes 170 is removed.
(4) The reject box 17 is removed.
(5) The door 10c is opened during power-off.

### <The Amounts of Money Held in the Coin Stackers 202>

(6) The coin deposit/withdrawal unit 12 is in an abnormal state.
(7) The exterior cover 10b is opened and the coin deposit/withdrawal unit 12 is pulled open.
(8) The exterior cover 10b is opened during power-off.

### <The Amount of Money Held in the Coin Cassette 213>

(9) The coin deposit/withdrawal unit 12 is in an abnormal state.
(10) The coin cassette 213 is removed.
(11) The exterior cover 10b is opened during power-off.

Examples of the foregoing “abnormal state” include a state in which paper money or coins is improperly fed, a state in which paper money or coins are abnormally accumulated in the paper money stackers 180 or the coin stackers 202, and a state in which the communications for the paper money deposit/withdrawal unit 11 and the coin deposit/withdrawal unit 12 are shut down.

These events are stored in the storage 32 illustrated in FIGS. 4 and 5 and are referred to in the quick check process later. In the quick check process, the controller 31 determines whether the amount of money in the relevant money container is definite or indefinite depending on whether any of the foregoing events has occurred in the money deposit/withdrawal machine 1, and determines whether to count the money in the relevant money container according to the determination result.

For example, at the time of execution of the quick check process, when none of the foregoing events (1) to (5) have occurred, the controller 31 determines that the amounts of money in the money containers (the paper money stackers 180 and the paper money cassettes 170) in the paper money deposit/withdrawal unit 11 are definite and does not count the paper money in the money containers (the paper money stackers 180 and the paper money cassettes 170). In addition, at the time of execution of the quick check process, when none of the foregoing events (6) to (8) have occurred, the controller 31 determines that the amounts of money in the six coin stackers 202 are definite and does not count the coins in the six coin stackers 202. Further, at the time of execution of the quick check process, if none of the foregoing events (9) to (11) have occurred, the controller 31 determines that the amount of money in the coin cassette 213 is definite and does not count the coins in the coin cassette 213.

In the present embodiment, the operator can set arbitrarily the condition for deciding which of the general check process and the quick check process to be executed. In the present embodiment, this condition is set by the days of a week according to the calendar. The set condition is stored as needed in the storage 32. The controller 31 executes either the quick check process or the general check process based on the condition stored in the storage 32.

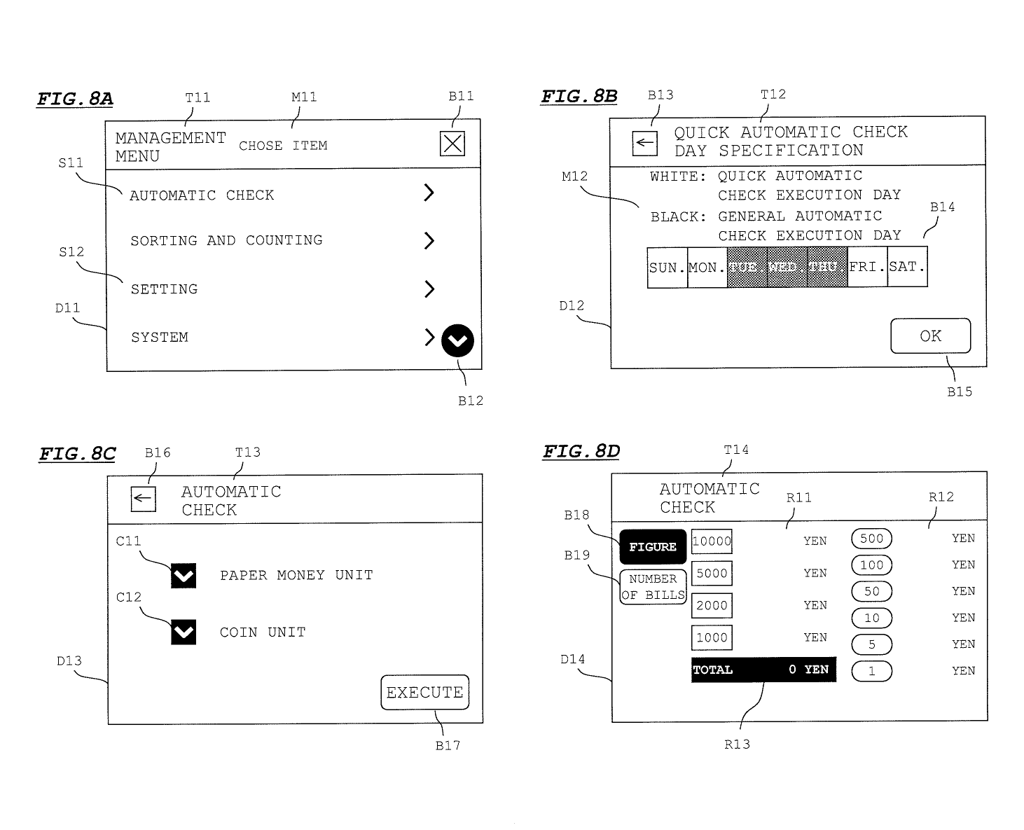

The check process in the money deposit/withdrawal machine 1 will be described below with reference to FIGS. 8A to 14B.

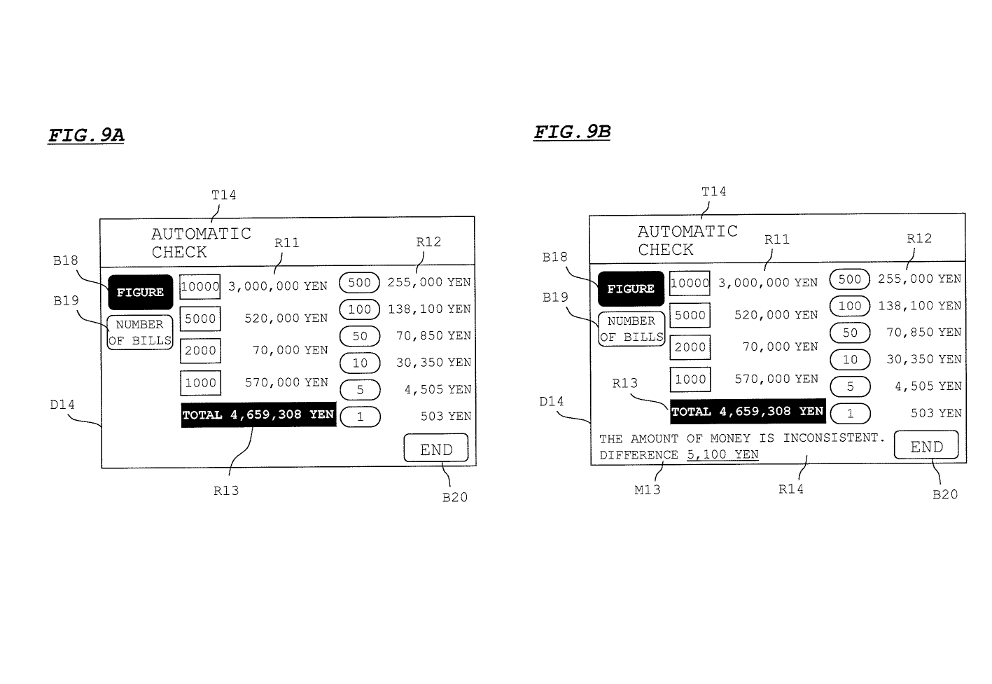

FIGS. 8A to 9B are diagrams illustrating screen transitions in the general check process. The screens illustrated in FIGS. 8A to 9B are displayed when the date of the check process does not apply to the day of a week for the quick check process. These screens are displayed on the operation display module 18 illustrated in FIG. 1.

When an operation for displaying a management menu is performed on the waiting screen, a screen D11 illustrated in FIG. 8A is displayed. The screen D11 contains a title T11 indicating the screen of the management menu, a message M11 for prompting the operator to select a menu item, selection items S11 for automatic check process, selection items S12 for making various settings, a button B11 for closing the screen D11, and a button B12 for scrolling the selection items. In this example, the current date applies to the day of a week for the general check process, and thus the indication of the selection items S11 includes “automatic check” as the general check process.

When the operator touches the selection items S12 on the screen D11, a selection screen (not illustrated) for selection of the setting items is displayed. When the operator then touches the selection item for setting the condition for switching between the check processes on the selection screen, a screen D12 illustrated in FIG. 8B is displayed.

The screen D12 contains a title T12 indicating the screen for setting the days of a week for the quick check process, a button B13 for returning to the previous screen, a button B14 for selecting the days of a week for the quick check process, a button B15 to be touched upon completion of selection and setting of the days of a week, and a message M12 for describing the indication of the button B14.

The user can touch desired ones of days displayed on the button B14 to specify the execution day of the quick check process. The user can also touch the once-specified day again to cancel the specification of the day. In this example, Tuesday, Wednesday, and Thursday are selected as the days of a week for the quick check process. After the selection of the desired days, the operator touches the button B15 to store the selected days as the days of a week for the quick check process in the storage 32.

When the operator touches the selection item S11 on the screen D11 illustrated in FIG. 8A, a screen D13 illustrated in FIG. 8C is displayed.

The screen D13 includes a title T13 indicating the screen for executing the general check process, a button B16 for returning to the previous screen, a button B17 for executing the general check process, and check boxes C11 and C12 for selecting modules to be subjected to the check process. In this example, both the paper money deposit/withdrawal unit 11 and the coin deposit/withdrawal unit 12 are selected as targets of the check process. In this state, when the operator touches the button B17, the general check process is performed on both the paper money deposit/withdrawal unit 11 and the coin deposit/withdrawal unit 12. When the button B17 is touched, a screen D14 illustrated in FIG. 8D is displayed.

The screen D14 includes a title T14 indicating the screen relating to the general check process, a button B18 for displaying the counting result of money in figure, a button B19 for displaying the counting result of money in the number of notes, a region R11 for displaying the counting result of paper money by denomination, a region R12 for displaying the counting result of coins by denomination, and a region R13 for displaying the total amount of counted money. In this example, the button B18 for displaying the counting result of money is selected. In the course of counting of the money in the paper money deposit/withdrawal unit 11 and the coin deposit/withdrawal unit 12, the amount of money of the individual denominations in the regions R11 and R12 increases, and the total amount of money in the region R13 increases accordingly.

Upon completion of counting of all the money, as illustrated in FIG. 9A, a button B20 is displayed to indicate the completion of the check process on the lower right part of the screen D14. At this time, if there is an inconsistency between the amount of money in the log information and the amount of money in the counting result, a message M13 is displayed to indicate the inconsistency, and the difference between the amounts of money is displayed in the region R14 as illustrated in FIG. 9B. The operator checks the screen D14 and touches the button B20. Accordingly, the general check process is terminated (the amount of money is confirmed), and the screen returns to the waiting screen.

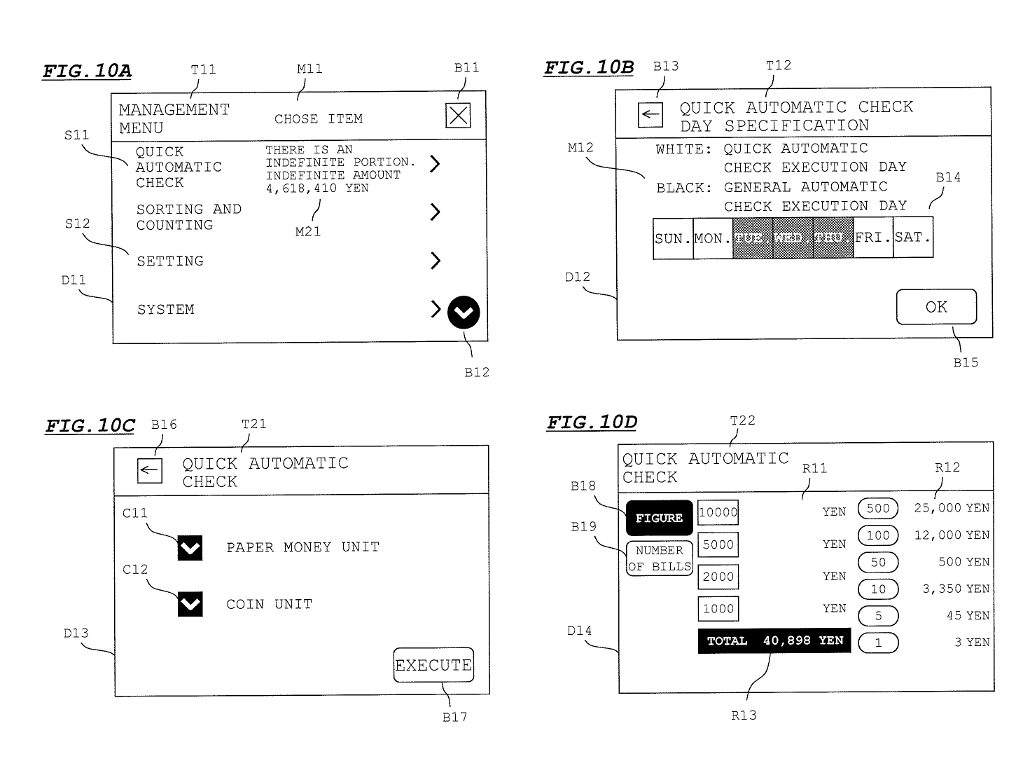

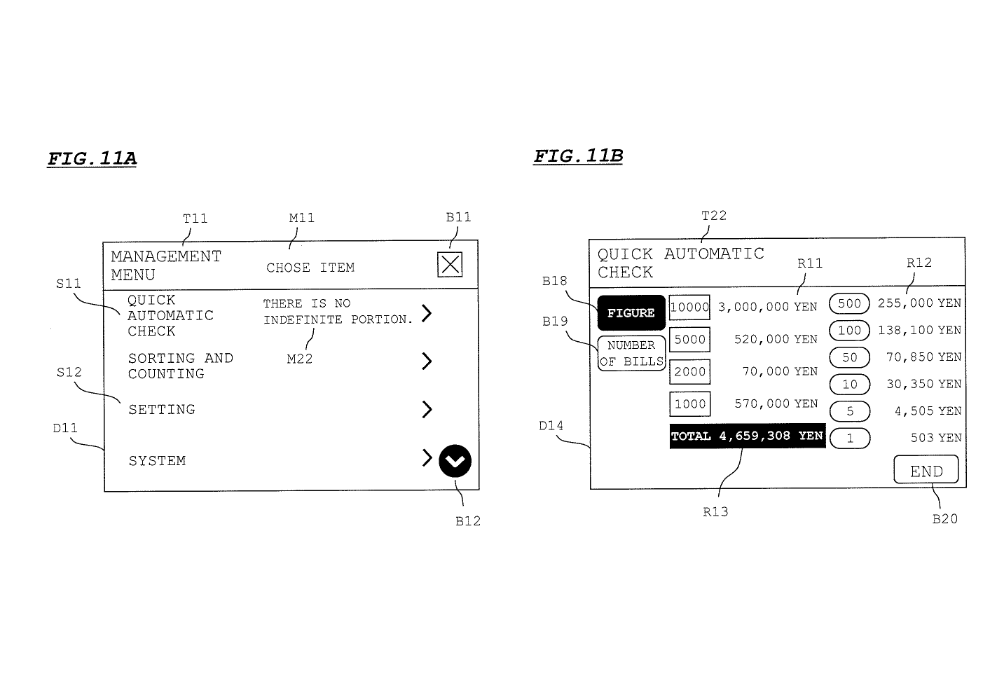

FIGS. 10A to 11B are diagrams illustrating screen transitions in the quick check process.

The screens illustrated in FIGS. 10A to 10D are similar to the screens illustrated in FIGS. 8A to 8D except for some indications. In the quick check process, as the general check process, the screen transitions take place according to screens D11 to D14 illustrated in FIGS. 10A to 10D.

However, in the quick check process, the titles of the screens D13 and D14 illustrated in FIGS. 10C and 10D are changed to titles T21 and T22 indicating the quick check process. In addition, on the screen D11 illustrated in FIG. 10A, the indication of the selection items S11 is changed to an indication for the quick check process, and the message M21 is provided to indicate that there is a portion (money container) where the amount of money is indefinite and how much the indefinite amount of money in that portion.

The “portion where the amount of money is indefinite” means a money storage module in which the amount of money is judged as indefinite based on the foregoing events (1) to (11). The “indefinite amount of money” indicates the amount of money stored in that portion based on the log information. The operator can refer to the message M21 to grasp the indefinite portion and the indefinite amount of money, and to know that the money in the portion will be counted in the quick check process.

When there is no indefinite portion, a message M22 illustrated in FIG. 11A is displayed instead of the message M21. The operator can refer to the message M22 to grasp that there is no indefinite portion or indefinite amount of money, and that the money in any of the money containers will not be counted in the quick check process.

In the quick check process, on the screen D14 illustrated in FIG. 10D, the definite amount of money is displayed in the region R11 or the region R12. In the example of FIG. 10D, it is assumed that only the amount of money in the coin cassette 213 is definite. The total definite amount of money is displayed in the region R13. The screen D14 is displayed only for a predetermined time after the button B17 on the screen D13 illustrated in FIG. 10C is touched. The operator can refer to this indication to grasp the definite amount of money by denomination, and roughly to know that in which of the money containers the amount of money is definite. After a lapse of the predetermined time, the figures in the regions R11 to R13 increase according to the counting of the money. The screen after the completion of the counting is identical to the screen illustrated in FIG. 9A or 9B.

When there is no indefinite portion in the quick check process, a screen D11 for the management menu illustrated in FIG. 11A is displayed. At this time, when the operator selects the selection item S11, the screen D13 illustrated in FIG. 10C is displayed. Further, when the operator selects the check boxes C11 and C12 on the screen D13 and then touches the button B17, a screen D14 illustrated in FIG. 11B is displayed. In this example, the amounts of money in all the money containers are definite, and thus the definite amounts of money of all the denominations are displayed in the regions R11 and R12, and the total amount is displayed in the region R13. In this case, the money will not be counted in any of the money containers, and thus the button B20 indicating the completion of the check process is contained from the beginning in the screen D14. The operator checks the contents of the screen D14 and then touches the button B20. Accordingly, the quick check process is terminated and the screen transition takes places to the waiting screen.

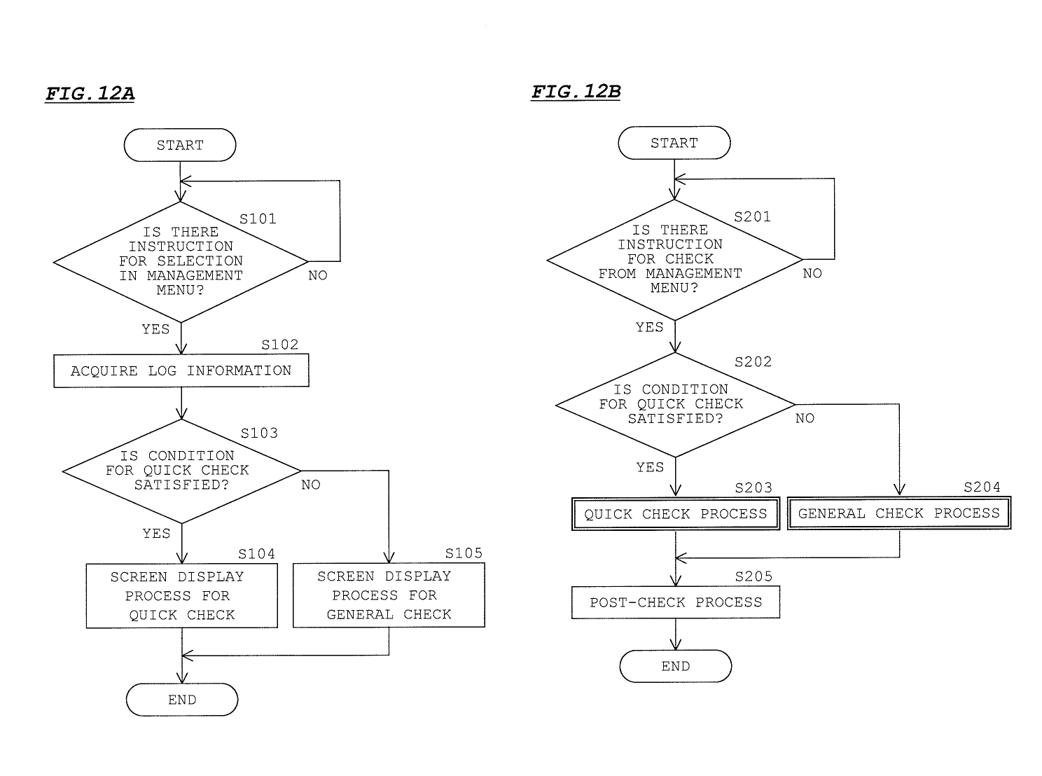

FIG. 12A is a flowchart of a screen display process at the check process.

The controller 31 monitors whether an instruction for selection of an item in the management menu has been received on the waiting screen (S101). When the instruction for selection in the management menu has been received (S101: YES), the controller 31 acquires the log information from the storage 32 (S102), and refers to the condition set for the quick check process and held in the storage 32 to determine whether the condition is satisfied (S103). Specifically, the controller 31 determines whether the current date applies to the day of a week as the condition set for the quick check process.

When the current date applies to the day of a week for the quick check process (S103: YES), the controller 31 executes a screen display process for the quick check process (S104), and causes transitions of screens to be displayed on the operation display module 18 according to the screens D11 to D14 illustrated in FIGS. 11A to 12B. On the other hand, when the current date does not apply to the day of a week for the quick check process (S103: NO), the controller 31 executes a screen display process for the general check process (S105), and causes transitions of screens to be displayed on the operation display module 18 according to the screens D11 to D14 illustrated in FIGS. 8A to 10B.

FIG. 12B is a flowchart of a check process.

The controller 31 monitors on the screen D11 of the management menu whether an instruction for selection of the check process has been received, that is, the selection item S11 has been touched (S201). When the instruction for selection of the check process has been received (S201: YES), the controller 31 determines whether the condition set for the quick check process is satisfied, specifically, whether the current date applies to the day of a week as the condition set for the quick check process (S202). When the condition set for the quick check process is satisfied (S202: YES), the controller executes the quick check process (S203), and when the condition set for the quick check process is not satisfied (S202: NO), the controller 31 executes the general check process (S204).

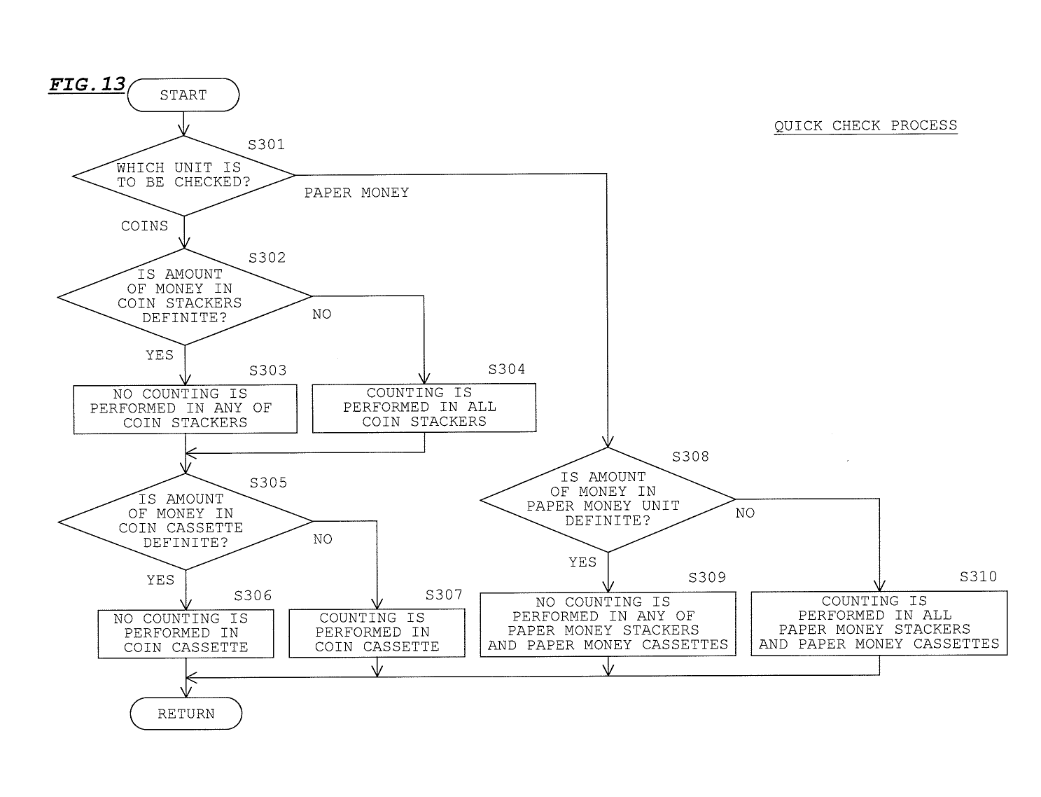

FIG. 13 is a flowchart of the quick check process (S203).

The controller 31 determines which of the paper money deposit/withdrawal unit 11 and the coin deposit/withdrawal unit is selected as target of the check process (S301). Specifically, the controller 31 determines whether either or both of the check boxes C11 and C12 are selected on the screen D13 illustrated in FIG. 10C. When only the check box C11 is selected, the controller 31 performs steps S308 to S310, and when only the check box C12 is selected, the controller 31 performs steps S302 to S307. When both the check boxes C11 and C12 are selected, the controller 31 performs both steps S302 to S307 and steps S308 to S310.

In step S302, the controller 31 determines whether the amounts of money in the six coin stackers 202 illustrated in FIG. 3 are definite (S302). Specifically, when none of the foregoing events (6) to (8) have occurred since the previous check process, the controller 31 determines that the amounts of money in the coin stackers 202 are definite. When the amounts of money in the coin stackers 202 are definite (S302: YES), the controller 31 moves the process to step S305 without counting the money in any of the coin stackers 202 (S303). On the other hand, when the amount of money in any of the coin stackers 202 is not definite (S302: NO), that is, when any of the foregoing events (6) to (8) has occurred since the previous check process, the controller 31 counts the money in all the coin stackers 202 (S304), and then moves the process to step S305.

In step S305, the controller 31 determines whether the amount of money in the coin cassette 213 illustrated in FIG. 3 is definite (S305). Specifically, when none of the foregoing events (9) to (11) have occurred since the previous check process, the controller 31 determines that the amount of money in the coin cassette 213 is definite. When the amount of money in the coin cassette 213 is definite (S305: YES), the controller 31 terminates the process without counting the money in the coin cassette 213 (S306). On the other hand, when the amount of money in the coin cassette 213 is not definite (S305: NO), that is, when any of the foregoing events (9) to (11) has occurred since the previous check process, the controller 31 counts the money in the coin cassette 213 (S307), and then terminates the process.

In step S308, the controller 31 determines whether the amount of money in the paper money deposit/withdrawal unit 11 (the paper money stackers 180 and the paper money cassettes 170) is definite (S308). Specifically, when none of the foregoing events (1) to (5) have occurred since the previous check process, the controller 31 determines that the amount of money in the paper money deposit/withdrawal unit 11 is definite. When the amount of money in the paper money deposit/withdrawal unit 11 is definite (S308: YES), the controller 31 terminates the process without counting the money in any of the three paper money stackers 180 and the two paper money cassettes 170 (S309). On the other hand, when the amount of money in the paper money deposit/withdrawal unit 11 is not definite (S308: NO), that is, when any of the foregoing events (1) to (5) has occurred since the previous check process, the controller 31 counts the money in the three paper money stackers 180 and the paper money cassettes 170 (S310), and then terminates the process.

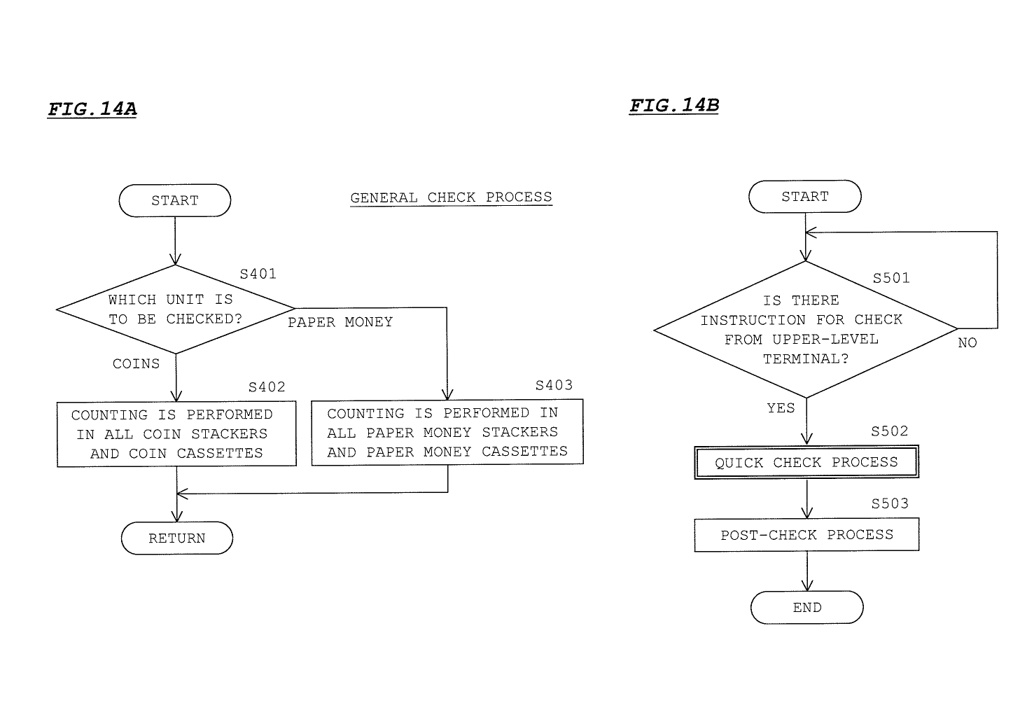

FIG. 14A is a flowchart of the general check process (S204).

As in the case of the quick check process, the controller 31 determines which of the paper money deposit/withdrawal unit 11 and the coin deposit/withdrawal unit 12 is selected as target of the check process (S401). Specifically, the controller 31 determines whether either or both the check boxes C11 and C12 are selected on the screen D13 illustrated in FIG. 8C. When only the paper money deposit/withdrawal unit 11 is selected as target of the check process, the controller 31 performs step S403, and when only the coin deposit/withdrawal unit 12 is selected as target of the check process, the controller 31 performs step S402. When both the paper money deposit/withdrawal unit 11 and the coin deposit/withdrawal unit 12 are selected as target of the check process, the controller 31 performs both step S402 and step S403.

In step S402, the controller 31 counts the money in the six coin stackers 202 and the coin cassette 213, and then terminates the process. In step S403, the controller 31 counts the money in the three paper money stackers 180 and the paper money cassettes 170, and then terminates the process.

Returning to FIG. 12B, after the execution of the quick check process (S203) or the general check process (S204) as described above, the controller 31 executes a post-check process (S205).

Specifically, in step S205, the controller 31 compares the amounts of money in the money storage modules with the amounts of money based on the transaction log to determine whether there is consistency between both the amounts of money. When there is no consistency between both the amounts of money, the controller 31 calculates the difference between both the amounts of money, and then executes a process for notifying the inconsistency between both the amounts of money and the difference between both the amounts of money. Accordingly, the message M13 illustrated in FIG. 9B is displayed and the difference in the amount is displayed in the region R14.

In the post-check process in step S205, the reject return described above is performed. Specifically, when the reject paper money or the reject coins are contained in the reject box 17 or the coin withdrawal box 16a, the operator extracts the reject paper money or the reject coins and put the reject paper money or the reject coins into the money deposit/withdrawal machine 1 to count the reject paper money or the reject coins. The button B20 illustrated in FIGS. 9A and 9B is displayed after the reject return is terminated and all the money is completely counted.

Accordingly, upon completion of check of all the money, the operator refers to the screen D14 illustrated in FIG. 9A, 9B, or 11B, and then touches the button B20. Accordingly, the check process described in FIG. 12B is terminated.

At the touch of the button B20, when there is inconsistency between the amounts of money in the money containers and the amounts of money based on the transaction log, notification information indicating the inconsistency and the difference between both the amounts of money may be transmitted to an administration computer, an administrator's personal computer, a mobile terminal, and the like through telecommunications. In this case, information for identifying the money deposit/withdrawal machine 1 such as information on the machine number of the money deposit/withdrawal machine 1 maybe transmitted together with the notification information.

FIG. 14B is a flowchart of a process with an instruction for check from the upper-level terminal 2.

In the present embodiment, there is an instruction for check from the upper-level terminal 2 (S501: YES), the quick check process is executed without exception regardless of the condition set for the check process (S502). Specifically, in the case where the days of a week set for the quick check process are Tuesday, Wednesday, and Thursday, when an instruction for check is received from the upper-level terminal 2 on Monday other than these set days of a week, the controller 31 executes the quick check process, not the general check process. The quick check process is executed according to the flowchart described in FIG. 13. The deposition/withdrawal units to be subjected to the check process (the paper money deposit/withdrawal unit 11 and the coin deposit/withdrawal unit 12) are specified by the upper-level terminal 2. After the termination of the quick check process in step S502, the controller 31 executes the post-check process (S503). The post-check process is the same as that in step S205 described in FIG. 12B.

In this way, since the check process to be performed under an instruction from the upper-level terminal 2 is fixed to the quick check process, the operator can perform the quick check process in a simple manner by using the upper-level terminal 2 even in the day of a week set for the general check process in the money deposit/withdrawal machine 1. The check process to be performed under an instruction from the upper-level terminal 2 may be fixed to the general check process. In addition, the check process to be performed under an instruction from the upper-level terminal 2 may be switchable between the quick check process and the general check process by the condition set for the check process.

### <Advantageous Effects of the Embodiment>

According to the present embodiment, the following advantageous effects can be produced.

Using the screen D12 illustrated in FIG. 8B makes it possible to switch between the quick check process and the general check process by the mode (the day of a week) desired by the user. Accordingly, the user can execute the quick check process or the general check process in the desired mode in consideration of the business schedule in the facility where the money processing device 1 is installed and the trend to operate the money deposit/withdrawal machine 1, for example. This enhances the convenience of the money deposit/withdrawal machine 1.

As illustrated in FIG. 13, in the quick check process, out of the plurality of money containers (the paper money stackers 180, the paper money cassettes 170, the coin stackers 202, and the coin cassette 213), the controller 31 does not count the money in the money containers without the occurrence of an event in which the amount of money may be indefinite (steps S303, S306, and S309) but counts the money in the money containers with the occurrence of such an event (S304, S307, and S310). In this way, in the quick check process, the money in only the money containers with the possibility that the amount of money maybe indefinite is counted, which makes it possible to execute the quick check process in a swift and efficient manner.

As illustrated in FIGS. 8B and 10B, the condition for deciding which of the quick check process and the general check process to be performed can be set by days of a week. Accordingly, it is possible to perform an operation in which, for example, the amount of money is simply checked by the quick check process at the days in the middle of a week, whereas the amount of money is checked more precisely by the general check process at the first and last days of a week. Besides, it is possible to switch from the quick check process to the general check process at randomdays of a week without prior notice. In this manner, according to the present embodiment, it is possible to switch between the quick check process and the general check process according to the desired schedule (days of a week).

As illustrated in FIG. 10A, at the occurrence of the event in which the amount of money may be indefinite in the quick check process, the controller 31 displays information indicating the indefinite amount of money (the message M21) on the operation display module 18. Accordingly, the operator can know that the money will be counted in the quick check process. The operator can also grasp immediately the figure of the indefinite amount of money from this information, and estimate in which of the money containers has occurred the event in which the amount of money may be indefinite, from the figure of the indefinite amount of money. This allows the operator to take proper and smooth measures based on the check process.

In the present embodiment, the information indicating the indefinite amount of money (the message M21) is displayed on the screen D11 in the quick check process illustrated in FIG. 10A. Besides, the information indicating the indefinite amount of money may be displayed on the screen D11 in the general check process illustrated in FIG. 8A. In addition, the information indicating the indefinite amount of money may be provided by sound together with the screen D11.

Further, the information indicating the indefinite amount of money may be transmitted by the communicator 33 to the upper-level terminal 2 or an external device such as an administration computer. In this case, when any of the foregoing events (1) to (11) has occurred, the controller 31 causes the communicator 33 to transmit the information indicating the indefinite amount of money to the external device in the quick check process or the general check process. For example, when making a YES determination in step S201 illustrated in FIG. 12B, the controller 31 causes the communicator 33 to transmit the information indicating the indefinite amount of money to the external device.

According to this configuration, at the external device, the administrator and others can check the information indicating the indefinite amount of money and roughly grasp from the amount of money in which of the money containers has occurred the event in which the amount of money may be indefinite. This allows the administrator and others to take measures based on the check process in a proper and smooth manner. This step may be executed at only either the quick check process or the general check process.

As illustrated in FIG. 10D, in the quick check process, the controller 31 causes the operation display module 18 to display the information indicating the definite amounts of money (the regions R12 and R13). This allows the operator to estimate in which of the money containers the amounts of money is definite. Accordingly, the operator can take measures based on the check process in a proper and smooth manner.

In the present embodiment, the information indicating the definite amounts of money (the regions R12 and R13) is displayed on the screen D14 in the quick check process illustrated in FIG. 10D. Besides, the information on the definite amounts of money may also be displayed on the screen D14 in the general check process illustrated in FIG. 8D. In addition, the information indicating the definite amounts of money may be provided by sound together with the screen D14.

### MODIFICATION EXAMPLE

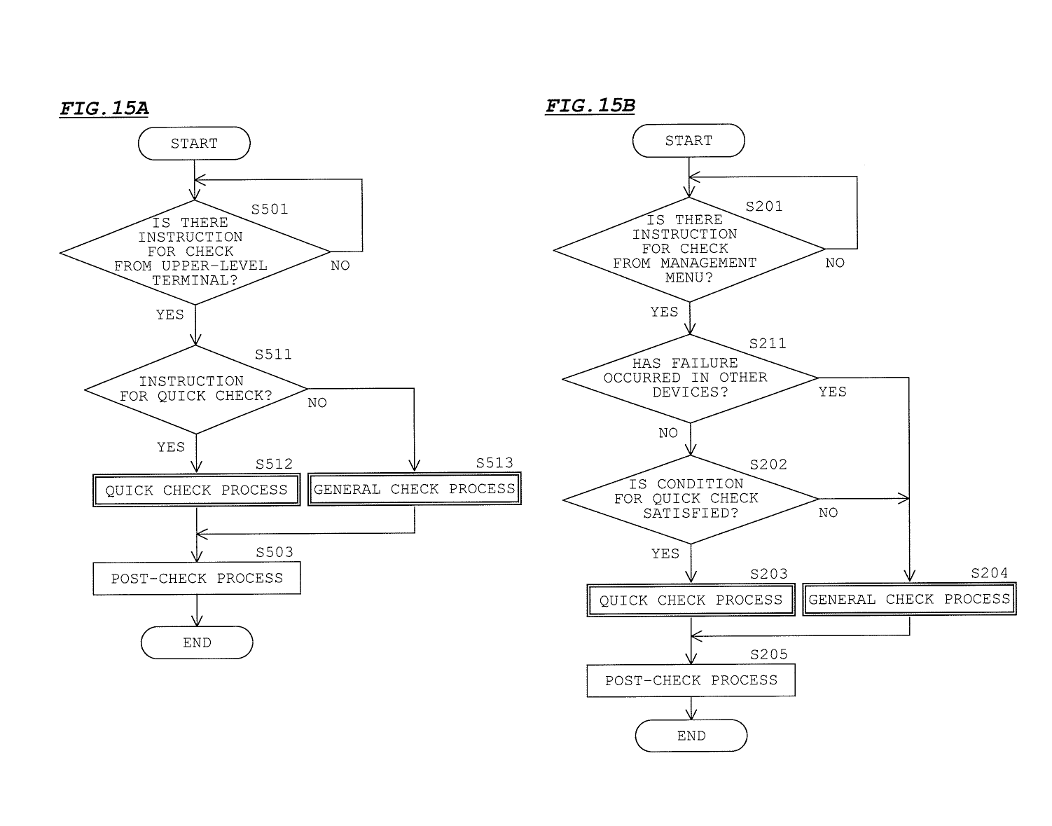

As illustrated in FIG. 14B, upon receipt of an instruction for check from the upper-level terminal 2, the controller 31 executes the quick check process without exception. Alternatively, the operator may arbitrarily set the quick check process and the general check process on the upper-level terminal 2. In this case, the flowchart in FIG. 14B is changed as described in FIG. 15A.

Specifically, referring to FIG. 15A, upon receipt of an instruction for check from the upper-level terminal 2 (S501: YES), the controller 31 determines which of the quick check process and the general check process is specified in the instruction for check (S511). When the quick check process is specified in the instruction for check (S511: YES), the controller 31 executes the quick check process (S512), and when the general check process is specified in the instruction for check (S511: NO), the controller 31 executes the general check process (S513). The quick check process (S512) and the general check process (S513) are respectively identical to the processes described in FIG. 13 and FIG. 14A.

According to this modification example, the operator can execute the desired check process as appropriate although it is necessary to select the quick check process or the general check process on the upper-level terminal 2.

The condition for switching between the quick check process and the general check process (in this example, the days of a week when the quick check process is to be executed) may be included in a setting file that is transmitted from the upper-level terminal 2 to the money deposit/withdrawal machine 1 at the start of the money deposit/withdrawal machine 1 or the like so that the condition for switching in the setting file is stored in the storage 32 of the money deposit/withdrawal machine 1. The setting file may be customized in advance for each facility by the manufacture or may be arbitrarily set by the operator on the upper-level terminal 2.

In the foregoing embodiment, switching takes place between the quick check process and the general check process based on the condition arbitrarily set by the user (in this example, the days of a week). Further, switching may take place between the quick check process and the general check process under other additional conditions.

For example, when a plurality of money deposit/withdrawal machines 1 or other money processing device such as cashiers are installed in the same facility, if a failure such as an error occurs at one device, the same failure may have occurred in another devices (the money may have been deposited or charged into the wrong device). In this case, it is regarded that the information on the amount of money in the money deposit/withdrawal machine 1 may be incorrect due to the failure in the other device.

In consideration of such an event, the controller 31 of the money deposit/withdrawal machine 1 may be configured to, upon receipt of a notification that a failure possibly relating to the amount of money has occurred in the other money processing device via the communicator 33, execute the general check process regardless of the condition arbitrarily set by the user.

In this case, the flowchart in FIG. 12B is changed as described in FIG. 15B. The flowchart of FIG. 15B includes additional step S211 as compared to the flowchart in FIG. 12B. When the operator selects the selection item S11 in the management menu illustrated in FIG. 8A or 10A, the controller 31 first determines whether, after the previous check process, a notification about occurrence of a failure possibly relating to the amount of money in the other money processing device has been received (S211). When the notification has been received (S211: YES), the controller 31 executes the general check process regardless of the condition arbitrarily set by the user (S204). When no notification has been received (S211: NO), the controller 31 moves the process to step S202 to determine whether the condition for the quick check process is satisfied. Step S202 and subsequent steps are the same as those in the flowchart of FIG. 12B.

According to this configuration, upon receipt of a notification that a failure possibly relating to the amount of money in the other money processing device, the general check process is executed regardless of the set condition, which makes it possible to manage the amounts of money in the money containers (the paper money stackers 180, the paper money cassettes 170, the coin stackers 202, and the coin cassette 213) in a more accurate manner.

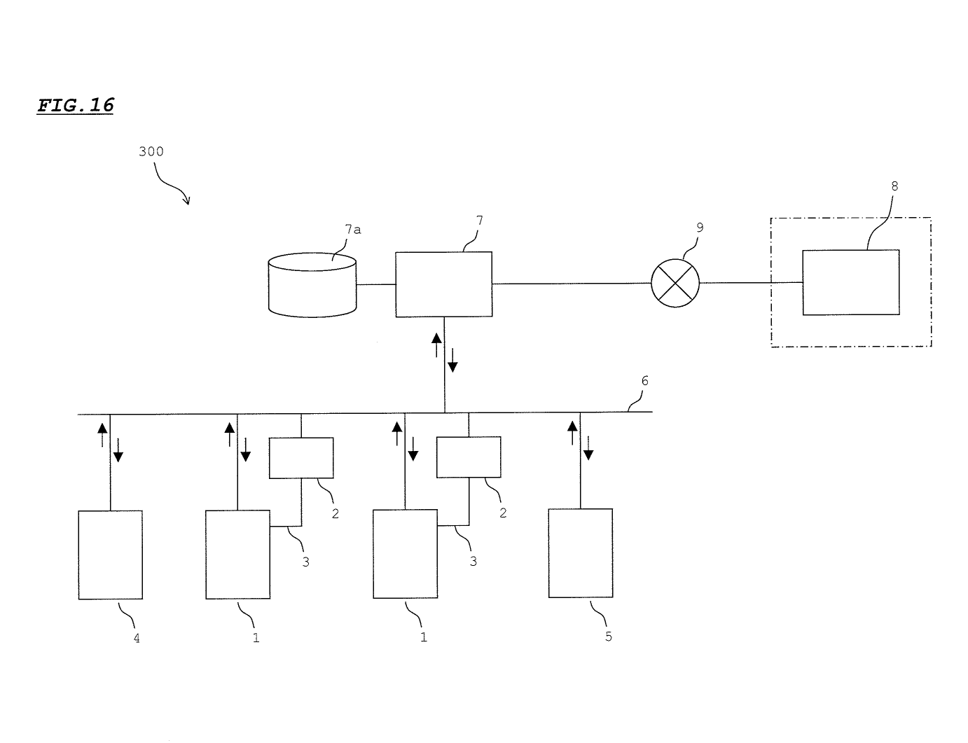

FIG. 16 is a diagram schematically illustrating a configuration example of a money processing system 300 for carrying out this modification example.

In this configuration example, the money processing system 300 is formed by connecting the two money deposit/withdrawal machines 1, a change machine 4, and a cashier 5 to an administration computer 7 via an LAN 6 established in a facility. The administration computer 7 is further connected to a computer 8 installed in a management center outside the facility via an external network 9.

The administration computer 7 manages the individual states of the money processing devices (the two money deposit/withdrawal machines 1, the change machine 4, and the cashier 5) in a management database 7a. The management database 7a stores as necessary various errors having occurred in the money processing devices (including inconsistency in the amount of money in the check process and the presence or absence of an event in which the amount of money may be indefinite).

Based on the information on the various errors received from the money processing devices, the administration computer 7 determines whether a failure possibly relating to the amount of money has occurred in each of the money processing devices. If such a failure has occurred, the administration computer 7 transmits a notification indicating this matter to the other money processing devices. For example, when there occurs an inconsistency in the amount of money in the check process on the cashier 5, the administration computer 7 transmits a notification indicating this manner to the two money deposit/withdrawal machines 1 and the change machine 4. In this case, in the money deposit/withdrawal machine 1, the determination result is YES in step S211 in FIG. 15B and the general check process is executed.

In the foregoing embodiment, the process described in FIGS. 12A to 14B or the process described in FIGS. 15A and 15B is applied to the money deposit/withdrawal machine 1. Besides, these processes may also be applied to the other money processing devices such as the change machine 4 and the cashier 5. The failures in the money processing devices maybe directly notified by each of the money processing devices to the other money processing devices, without intervention of the administration computer 7.

In the foregoing embodiment, the condition for switching between the quick check process and the general check process is set and the determination is made based on the condition in the money deposit/withdrawal machine 1. Alternatively, the setting and the determination may be made in the administration computer 7. In this case, the administration computer 7 determines based on the set condition which of the quick check process and the general check process to be executed, and transmits an instruction for check based on the determination result to the money processing devices (the two money deposit/withdrawal machines 1, the change machine 4, and the cashier 5). In each of the money processing devices, either the quick check process or the general check process is executed based on the received instruction for check. According to this configuration, the same advantageous effects as those of the foregoing embodiment can be produced.

In the foregoing embodiment, as illustrated in FIG. 10A, the information indicating the indefinite portion and the indefinite amount of money (the message M21) is displayed on the screen D11 of the management menu. Alternatively, this information may be displayed on another screen. Similarly, the information indicating the definite amount of money may be displayed on a screen other than the screen D14 illustrated in FIG. 11B.

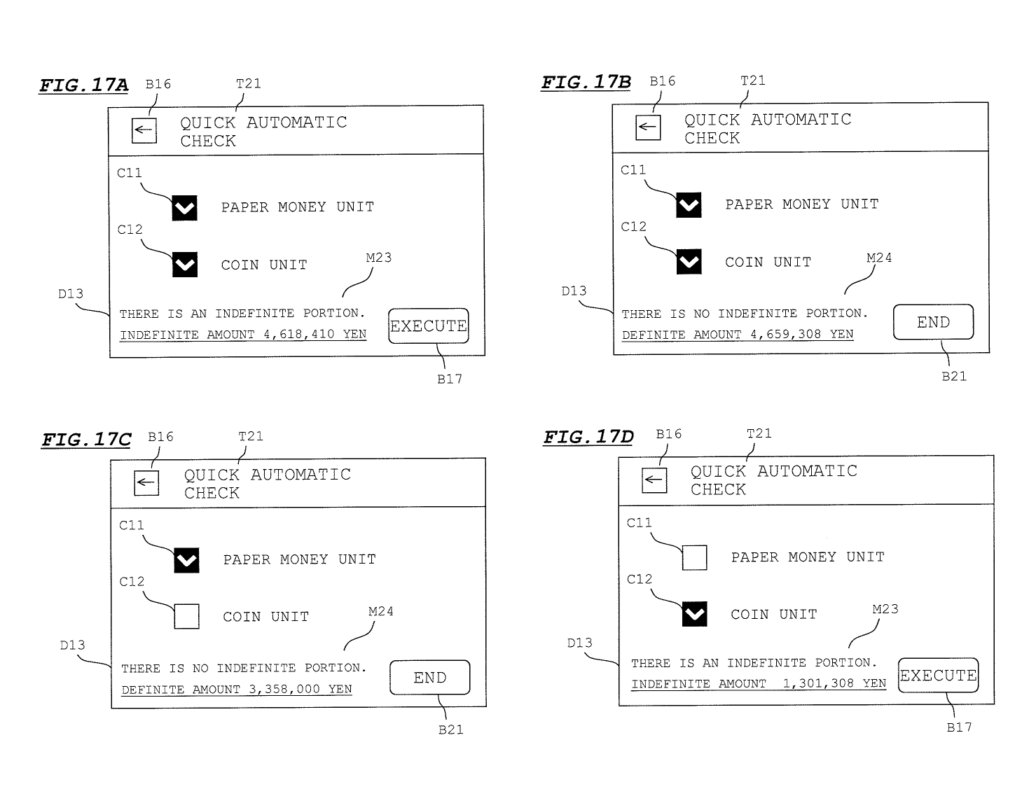

For example, as illustrated in FIG. 17A, when it is found in the quick check that the amount of money is indefinite in any of money containers, the information indicating the presence of the indefinite portion and the indefinite amount of money (a message M23) may be displayed on the screen D13 for selecting the unit to be subjected to the check process. In addition, as illustrated in FIG. 17B, when it is found in the quick check process that there is no money container in which the amount of money is indefinite, the information indicating the absence of an indefinite portion and the definite amount of money (a message M24) may be displayed on the screen D13 for selecting the unit to be subjected to the check process.

In this case, whether there is any indefinite portion is determined and the determination result is displayed in each of the paper money deposit/withdrawal unit 11 and the coin deposit/withdrawal unit 12. For example, in the case where there is an indefinite portion in only the coin deposit/withdrawal unit 12, when the specification of the coin deposit/withdrawal unit 12 is canceled as illustrated in FIG. 17C, the message M23 displayed on the screen D13 illustrated in FIG. 17A is changed to the message M24 indicating the absence of an indefinite portion and the definite amount of money. In this case, the message M24 includes the definite amount of money in the paper money deposit/withdrawal unit 11.

In addition, in the case where there are indefinite portions in both the paper money deposit/withdrawal unit 11 and the coin deposit/withdrawal unit 12, for example, when the specification of the paper money deposit/withdrawal unit 11 is canceled as illustrated in FIG. 17D, the indefinite amount of money in the message M23 on the screen D13 illustrated in FIG. 17A is changed to the indefinite amount of money in the coin deposit/withdrawal unit 12.

According to the display method illustrated in FIGS. 17A to 17D, the operator can know whether the amount of money is definite and the indefinite amount of money and the definite amount of money in each of the paper money deposit/withdrawal unit 11 and the coin deposit/withdrawal unit 12.

In the foregoing embodiment, the condition for deciding which of the quick check process and the general check process to be performed is days of a week. However, the mode for setting the condition is not limited to days of a week. For example, the condition may be dates or time zone.

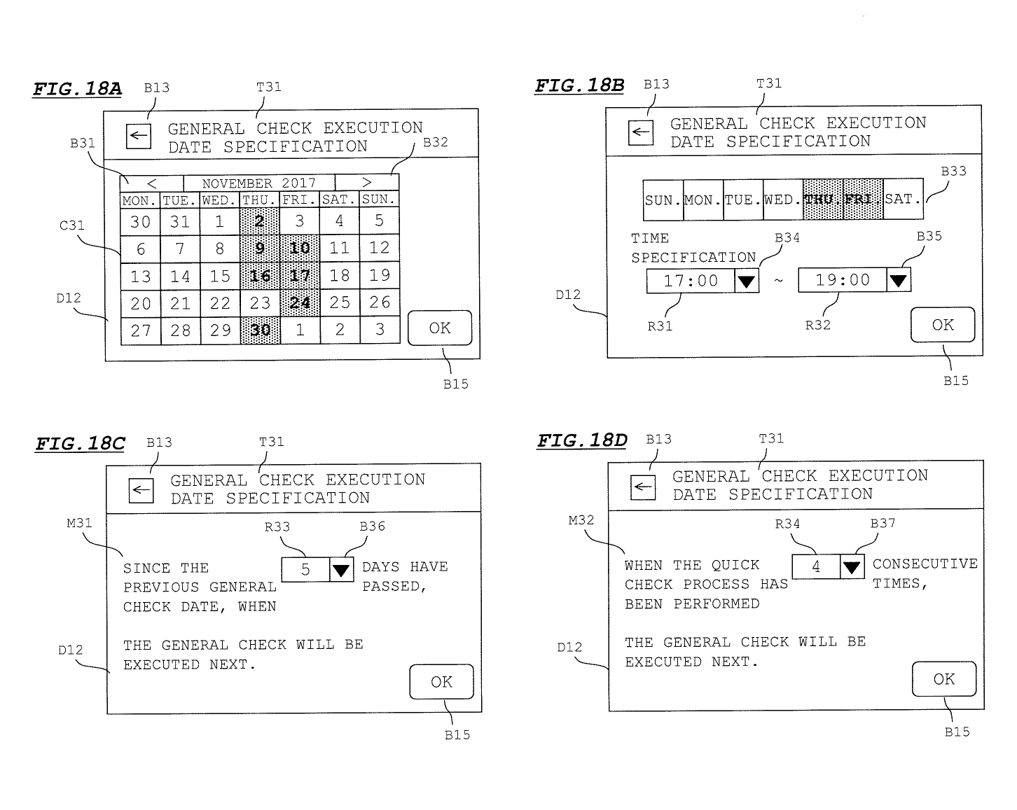

FIG. 18A is a diagram illustrating the screen D12 for setting the dates of execution of the general check process as the condition.

The screen D12 includes a title T31 indicating the screen for setting the dates of execution of the general check process, buttons B31 and B32 for moving to the previous month or the next month, and columns C31 for selecting the dates of execution of the general check process. When the button B31 or B32 is touched, the calendar displayed in the columns C31 is changed to the previous month or the next month.

The user can touch the desired date in the columns C31 to specify the date of execution of the general check process. The user can also touch the once specified execution date again to cancel the specification of the date. In this example, November 2, 9, 10, 16, 17, 24, and 30 are selected as the dates of execution of the general check process. November 3 and 23 are holidays when no business will be performed, which are excluded from the dates of execution of the general check process. When the user touches the button B15, the dates specified in the columns C31 are stored in the storage 32 as the dates of execution of the general check process.

FIG. 18B is a diagram illustrating the screen D12 for setting the days of a week and time zone of the general check process as the condition.

The screen D12 includes a button B33 for specifying the days of a week of execution of the general check process, regions R31 and R32 for specifying the start and end times, and buttons B34 and B35 for changing the start and end times. When the user touches the button B34 or B35, the candidates for selection of the times are displayed in a scrollable manner. When the user then selects one of the displayed candidates for selection (times), the selected time is specified as the start time or the end time. In this example, 17:00 and 19:00 are respectively specified for the start time and the end time.

After that, when the user touches the button B15, the days of a week specified by the button B33 and the time zone specified in the regions R31 and R32 are stored as the days of a week and time zone of execution of the general check process in the storage 32. In the example of FIG. 18B, Thursday and Friday are set as the days of a week of execution of the general check process and 17:00 to 19:00 is set as the time zone of execution of the general check process. In this case, the general check process is executed when the check process is executed on Thursdays and Fridays from 17:00 to 19:00, and the quick check process is executed when the check process is executed on the other days and time zone.

In the example of FIG. 18B, the condition for executing the general check process is set by a combination of days of a week and time zone. Alternatively, the condition may be set by a combination of days and time zone, or may be set by only time zone.

Besides, the condition for deciding which of the quick check process and the general check process to be performed may be set by the intervals or number of times of check processes.

FIG. 18C is a diagram illustrating a screen D12 for setting the intervals between executions of the general check process as the condition.

The screen D12 includes a message M31 for describing the method for setting the general check process, and a region R33 and a button B36 for setting the intervals between executions of the general check process. When the user touches the button B36, the candidates for selection of the number of days are displayed in a scrollable manner. When the user then selects one of the displayed candidates (the numbers of days) for selection, the selected number of days is displayed in the region R33. In this example, five days is specified as the number of days. In this case, the message M31 indicates that, after a lapse of five days from the previous general check process, the general check process will be executed in the next check process. After that, when the user touches the button B15, the number of days specified in the region R33 is stored as the condition for executing the general check process in the storage 32.

FIG. 18D is a diagram illustrating a screen D12 for setting the number of executions of the quick check process.

The screen D12 includes a message M32 for describing the method for setting the general check process, and a region R34 and a button B37 for setting the number of executions of the quick check process. When the user touches the button B37, the candidates for selection of the number of executions are displayed in a scrollable manner. When the user selects one of the displayed candidates (the number of executions) for selection, the selected number of executions is displayed in the region R34. In this example, four times is specified as the number of executions. In this case, the message M32 indicates that, when the quick check process is executed four consecutive times since the previous general check process, the general check process will be executed in the next check process. After that, when the user touches the button B15, the number of times specified in the region R34 is stored as the condition for executing the general check process in the storage 32.

According to the configuration illustrated in FIGS. 18C and 18D, it is possible to perform an operation such as setting the check processes such that, when the general check process is not executed for a predetermined number of days or when the quick check process is performed consecutively a predetermined number of times, the general check process will be executed in the next check process. Accordingly, it is possible to prevent the money in the money containers (the paper money stackers 180, the paper money cassettes 170, the coin stackers 202, and the coin cassette 213) from remaining uncounted for a long period of time. Therefore, the amount of money in the money containers can be properly checked.

The method for setting the condition illustrated in FIGS. 18C and 18D may be used in combination with the methods for setting the condition illustrated in FIGS. 8B and 10B or in combination with the method for setting the condition illustrated in FIGS. 18A and 18B.

The condition may be set by the number of executions of the check process such that, when the quick check process is performed consecutively a predetermined number of times for a predetermined period of time (for example, one day), the general check process will be performed in the next check process. Besides, the condition may be set such that, when the money deposit/withdrawal machine 1 is repeatedly powered on and off a predetermined number of times (for example, four times) without execution of the check process (in particular, the general check process), the general check process will be performed in the next check process. This makes it possible to ensure the correctness of the amount of money in a more reliable manner.

For example, when the money deposit/withdrawal machine 1 is powered on and off more frequently than usual, it is considered that the amount of money may be indefinite due to some failure in the money deposit/withdrawal machine 1. Therefore, the condition may be set such that, when the money deposit/withdrawal machine 1 is powered on and off plural times a day, for example, the general check process will be executed in the next check process. Besides, the condition may be set such that, when a predetermined number of transactions (deposit and withdrawal) is performed (for example, 100 times), the general check process will be performed in the next check process.

In the foregoing embodiment, the operation display module 18 is formed by integrating the operation module and the display module. Alternatively, the operation module and the display module may be separately formed or the operation display module 18 may be provided separately from the main body 10a and connected to the main body 10a in a wireless or wired manner. In this case, the controller 31, the storage 32, and the communicator 33 illustrated in FIGS. 4 and 5 may be provided on the operation display module 18.

In the foregoing embodiment, the money deposit/withdrawal machine 1 including the paper money deposit/withdrawal unit 11 and the coin deposit/withdrawal unit 12 is taken as an example of the money processing device of the present invention. Alternatively, the present invention may be applied to a paper money deposit/withdrawal machine including only the paper money deposit/withdrawal unit 11 or a coin deposit/withdrawal machine including only the coin deposit/withdrawal unit 12.

Besides, the embodiment of the present invention can be changed as appropriate without deviating from the scope of the claim.

What is claimed is:

1. A money processing device comprising:
at least one money container that contains money;
a controller operable to control a process on the money container; and
a storage, wherein
the storage stores a condition for deciding which of a plurality of check processes to be performed, wherein the plurality of check processes include:
a quick check process in which the money in the at least one money container is not counted when an event in which an amount of money held in the at least one money container may become indefinite has not occurred; and
a general check process in which the money in the at least one money container is counted regardless of the presence or absence of an occurrence of the event, and
the controller executes one of the quick check process and the general check process based on the condition stored in the storage.

2. The money processing device according to claim 1, wherein the at least one money container comprises a plurality of the money containers, and
in the quick check process, amongst the plurality of money containers, the controller does not count the money in the money containers without the event but counts the money in the money containers with the event.

3. The money processing device according to claim 1, wherein the condition includes at least one of a date, a day of a week, and a time zone.

4. The money processing device according to claim 1, wherein the condition includes a number of executions of the plurality of check processes.

5. The money processing device according to claim 1, wherein the condition includes an interval between executions of the plurality of check processes.

6. The money processing device according to claim 1, comprising a display, wherein
with the occurrence of the event, the controller is operable to display information indicating an indefinite amount of money on the display at the time of a check process of the plurality of check processes.

7. The money processing device according to claim 1, comprising a display, wherein
the controller is operable to display information indicating a definite amount of money on the display at the time of a check process of the plurality of check processes.

8. The money processing device according to claim comprising a communicator, wherein
with the occurrence of the event, the controller causes the communicator to transmit information indicating an indefinite amount of money to an external device at the time of a check process of the plurality of check processes.

9. The money processing device according to claim 1, comprising a communicator, wherein
upon receipt of a notification that a failure possibly relating to an amount of money has occurred in another money processing device via the communicator, the controller executes the general check process regardless of the condition.

10. A money processing system comprising a money processing device with a money container and a management device connected to the money processing device, further comprising:
a controller; and
a storage, wherein
the storage stores a condition for deciding which of a plurality of check processes to be performed, wherein the plurality of check processes include:
a quick check process in which the money in the money container is not counted when an event in which the amount of money held in the money container may become indefinite has not occurred; and
a general check process in which the money in the money container is counted regardless of the presence or absence of an occurrence of the event, and
the controller executes either the quick check process or the general check process based on the condition stored in the storage.
